(19) United States
(12) Patent Application Publication
(10) Pub. No.: US 2025/0350184 A1
(43) Pub. Date: Nov. 13, 2025

(54) NON-ISOLATED SWITCHING CONVERTER WITH SHORT CIRCUIT PROTECTION

(71) Applicant: Chengdu Monolithic Power Systems Co., Ltd., Chengdu (CN)

(72) Inventors: Fengchun He, Hangzhou (CN); Junjie Feng, San Jose, CA (US); Daocheng Huang, San Jose, CA (US); Xu Han, Hangzhou (CN)

(21) Appl. No.: 19/203,968

(22) Filed: May 9, 2025

(30) Foreign Application Priority Data
May 10, 2024 (CN) 202410580856.4

(51) Int. Cl. H02M 1/00; H02M 1/088; H02M 3/158

(52) U.S. Cl. CPC H02M 1/0048; H02M 1/088; H02M 3/158

(57) ABSTRACT

A non-isolated switching converter receives a first voltage between a first voltage terminal and a first voltage return terminal and provides a second voltage between a second voltage terminal and a second voltage return terminal in a forward mode, and provides the first voltage between the first voltage terminal and the first voltage return terminal and receives the second voltage between the second voltage terminal and the second voltage return terminal in a reverse mode. The non-isolated switching converter has a protection switch, a high voltage side circuit coupled to the first voltage terminal via the protection switch, and a low voltage side circuit coupled to the second voltage terminal. The high voltage side circuit has two switches coupled in series and one of them is coupled with the protection switch in a back-to-back manner. The low voltage side circuit has a switch coupled to the high voltage side circuit.

### CROSS-REFERENCE TO RELATED APPLICATIONS

This application claims the benefit of CN application No. 202410580856.4, filed on May 10, 2024, and incorporated herein by reference.

### BACKGROUND OF THE INVENTION

### 1. Field of the Invention

The present invention generally refers to electrical circuits, and more particularly but not exclusively refers to non-isolated switching converters.

### 2. Description of Related Art

DC/DC switching converters convert a DC input voltage into a regulated DC output voltage. For example, a boost converter provides a DC output voltage higher than the DC input voltage, a buck converter provides a DC output voltage lower than the DC input voltage, a buck-boost converter can provide a DC output voltage higher or lower than the DC input voltage, and can provide a regulated DC output voltage at the same level as the DC input voltage.

There are already various circuit topologies that can realize the DC/DC switching converters mentioned above, such as hard-switching bridge circuits, phase shift soft-switching bridge circuits, soft-switching bridge circuits with series resonant tanks, and switched-capacitor converter circuits. The existing DC/DC switching converters have drawbacks including low efficiency, low power density, and high manufacturing costs, etc.

### SUMMARY OF THE INVENTION

It is one of the objects of the present invention to provide a non-isolated switching converter with short circuit protection.

Embodiments of the present invention are directed to a non-isolated switching converter, comprising a first voltage terminal, a first voltage return terminal, a second voltage terminal, a second voltage return terminal, a first protection switch, a high voltage side circuit, and a low voltage side circuit. The second voltage return terminal is coupled to the first voltage return terminal. The first protection switch is coupled to the first voltage terminal. The high voltage side circuit comprises a first terminal, a second terminal, and a first switch and a second switch coupled in series between the first terminal and the second terminal of the high voltage side circuit. The first terminal of the high voltage side circuit is coupled to the first voltage terminal via the first protection switch, and the first protection switch and the first switch are coupled in a back-to-back manner. The low voltage side circuit is coupled to the second voltage terminal and the second voltage return terminal. The low voltage side circuit comprises a third switch coupled between the second terminal of the high voltage side circuit and the second voltage return terminal. In response to a forward mode, the non-isolated switching converter is configured to receive a first voltage between the first voltage terminal and the first voltage return terminal and provide a second voltage between the second voltage terminal and the second voltage return terminal. In response to a reverse mode, the non-isolated switching converter is configured to provide the first voltage between the first voltage terminal and the first voltage return terminal and receive the second voltage between the second voltage terminal and the second voltage return terminal.

Embodiments of the present invention are directed to a non-isolated switching converter, comprising a first voltage terminal, a first voltage return terminal, a second voltage terminal, a second voltage return terminal, a first protection switch, a second protection switch, a high voltage side circuit, a low voltage side circuit, and an energy storage circuit. The first protection switch and the second protection switch are coupled to the first voltage terminal. The high voltage side circuit comprises a first terminal, a second terminal, a third terminal, a fourth terminal, a first switch and a second switch coupled in series between the first terminal and the second terminal of the high voltage side circuit, and a third switch and a fourth switch coupled in series between the third terminal and the fourth terminal of the high voltage side circuit. The first terminal of the high voltage side circuit is coupled to the first voltage terminal via the first protection switch, and the third terminal of the high voltage side circuit is coupled to the first voltage terminal via the second protection switch, and wherein the first protection switch and the first switch are coupled in a back-to-back manner, and the second protection switch and the third switch are coupled in the back-to-back manner. The low voltage side circuit is coupled to the second voltage terminal and the second voltage return terminal. The low voltage side circuit comprises a fifth switch coupled between the second terminal of the high voltage side circuit and the second voltage return terminal, and a sixth switch coupled between the fourth terminal of the high voltage side circuit and the second voltage return terminal. The energy storage circuit comprises a first terminal and a second terminal. The first terminal of the energy storage circuit is coupled to a common node of the first switch and the second switch, and the second terminal of the energy storage circuit is coupled to a common node of the fourth switch and the fifth switch. In response to a forward mode, the non-isolated switching converter is configured to receive a first voltage between the first voltage terminal and the first voltage return terminal and provide a second voltage between the second voltage terminal and the second voltage return terminal. In response to a reverse mode, the non-isolated switching converter is configured to provide the first voltage between the first voltage terminal and the first voltage return terminal and receive the second voltage between the second voltage terminal and the second voltage return terminal.

Embodiments of the present invention are directed to a control method for a non-isolated switching converter, comprising coupling the non-isolated switching converter to a second voltage terminal of the non-isolated switching converter via a low voltage side circuit, providing a first driving signal by a first driver to drive the protection switch and providing a second driving signal by a second driver to drive the first switch both based on a first control signal, providing a third driving signal based on a second control signal by a third driver to drive the second switch, and providing a fourth driving signal based on a third control signal by a fourth driver to drive the third switch. Wherein the low voltage side circuit comprises a third switch coupled between the second terminal of the high voltage side circuit and a voltage return terminal.

These and other features of the present invention will be readily apparent to persons of ordinary skill in the art upon reading the entirety of this disclosure, which includes the accompanying drawings and claims.

### BRIEF DESCRIPTION OF DRAWINGS

The present invention can be further understood with reference to the following detailed description and the appended drawings, wherein like elements are provided with like reference numerals.

FIG. 1 schematically shows a circuit diagram of a power supply system 100 in accordance with an embodiment of the present invention.

FIG. 2 schematically shows a circuit diagram of a non-isolated switching converter 200 in accordance with an embodiment of the present invention.

FIG. 3 schematically shows a circuit diagram of a non-isolated switching converter 300 in accordance with an embodiment of the present invention.

FIG. 4A schematically shows the non-isolated switching converter 300 working in a first switching mode in accordance with an embodiment of the present invention.

FIG. 4B schematically shows the non-isolated switching converter 300 working in a second switching mode in accordance with an embodiment of the present invention.

FIG. 5 schematically shows the non-isolated switching converter 300 working in a third switching mode in accordance with an embodiment of the present invention.

FIG. 6 schematically shows a circuit diagram of a non-isolated switching converter 400 in accordance with an embodiment of the present invention.

FIG. 7 schematically shows a circuit diagram of a charging circuit 246 in accordance with an embodiment of the present invention.

FIG. 8 schematically shows a circuit diagram of a non-isolated switching converter 500 in accordance with an embodiment of the present invention.

FIG. 9 schematically shows a circuit diagram of a non-isolated switching converter 600 in accordance with an embodiment of the present invention.

FIG. 10 schematically shows a circuit diagram of a non-isolated switching converter 700 in accordance with an embodiment of the present invention.

FIG. 11 schematically shows a circuit diagram of a non-isolated switching converter 700B in accordance with an embodiment of the present invention.

FIG. 12 schematically shows a circuit diagram of a non-isolated switching converter 800 in accordance with an embodiment of the present invention.

FIG. 13 schematically shows a circuit diagram of a non-isolated switching converter 900 in accordance with an embodiment of the present invention.

FIG. 14A schematically shows the non-isolated switching converter 900 working in the first switching mode in accordance with an embodiment of the present invention.

FIG. 14B schematically shows the non-isolated switching converter 900 working in the second switching mode in accordance with an embodiment of the present invention.

FIG. 15A schematically shows the non-isolated switching converter 900 working in the third switching mode in accordance with an embodiment of the present invention.

FIG. 15B schematically shows the non-isolated switching converter 900 working in a fourth switching mode in accordance with an embodiment of the present invention.

FIG. 16 schematically shows a circuit diagram of a non-isolated switching converter 900A in accordance with an embodiment of the present invention.

FIG. 17 schematically shows a circuit diagram of a non-isolated switching converter 1000 in accordance with an embodiment of the present invention.

FIG. 18 schematically shows a circuit diagram of a non-isolated switching converter 1100 in accordance with an embodiment of the present invention.

FIG. 19 schematically shows a driving integrated circuit (IC) 111 in accordance with an embodiment of the present invention.

FIG. 20 shows waveforms 230 of the non-isolated switching converter 1100 shown in FIG. 18 in accordance with an embodiment of the present invention.

FIG. 21 schematically shows a circuit diagram of a non-isolated switching converter 1200 in accordance with an embodiment of the present invention.

FIG. 22 schematically shows a driving IC 81 in accordance with an embodiment of the present invention.

FIG. 23 illustrates a control method 26 for a non-isolated switching converter in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications, and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

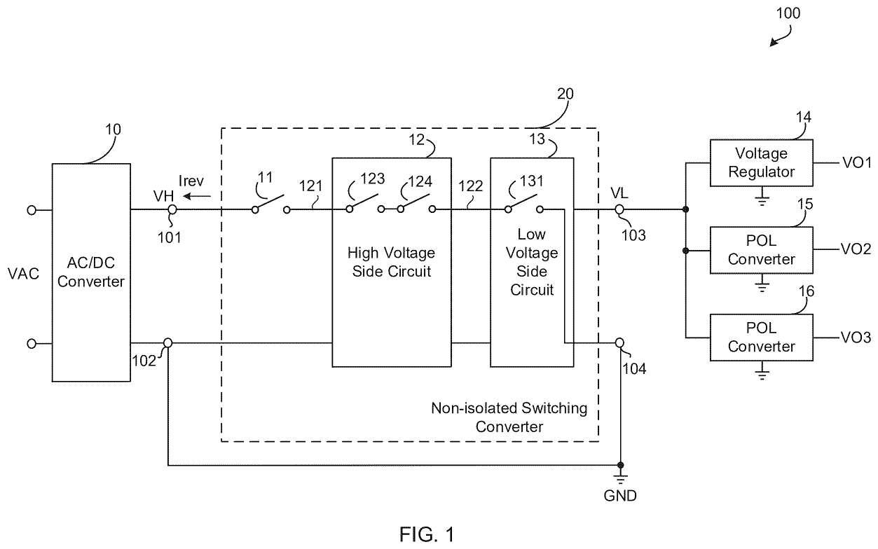

FIG. 1 schematically shows a circuit diagram of a power supply system 100 in accordance with an embodiment of the present invention. The power supply system 100 comprises three stages of power supply. As shown in FIG. 1, an AC-to-DC converter 10 is a first-stage power supply, a non-isolated switching converter 20 is a second-stage power supply, a voltage regulator 14 and point-of-load (POL) converters 15-16 form a third-stage power supply which supplies different power to a plurality of loads. For example, the voltage regulator 14 provides a power supply voltage VO1 to a processor, and the POL converters 15-16 provides power supply voltages VO2-VO3 to a plurality of POL loads respectively. One with ordinary skill in the art should understand that the circuit structure of the third-stage power supply is not limited by the embodiment of FIG. 1. In some embodiments, the third-stage power supply may comprise different numbers of the voltage regulators and the POL converters, and may also comprise other types of converters. In one embodiment, the AC-to-DC converter 10 receives an AC input voltage VAC and converts the AC input voltage VAC to a DC voltage VH. The AC input voltage VAC may be 220V/50 Hz. The non-isolated switching converter 20 receives the voltage VH and converts the voltage VH to a DC voltage VL, which is provided to the next stage of power supply (i.e., the third-stage power supply). The voltage VL is lower than the voltage VH, e.g., the voltage VH may be 48V and the voltage VL may be 5V. In one embodiment, the non-isolated switching converter 20 may be operated in a forward mode, i.e., the non-isolated switching converter 20 receives the voltage VH between a voltage terminal 101 and a voltage return terminal 102, and provides the voltage VL between a voltage terminal 103 and a voltage return terminal 104. In one embodiment, the non-isolated switching converter 20 may also be operated in a reverse mode, i.e., the non-isolated switching converter 20 receives the voltage VL between the voltage terminal 103 and the voltage return terminal 104, and provides the voltage VH between the voltage terminal 101 and the voltage return terminal 102.

In the embodiment of FIG. 1, the non-isolated switching converter 20 comprises a protection switch 11 coupled to the voltage terminal 101, a high voltage side circuit 12, and a low voltage side circuit 13. When the voltage terminal 101 is shorted to the reference ground, the protection switch 11 is configured to prevent a current Irev flowing from the voltage terminal 103 to the voltage terminal 101, so that to prevent the non-isolated switching converter 20 from damage caused by internal protection failure. The high voltage side circuit 12 has a first terminal 121, a second terminal 122, and at least two switches coupled in series between the first terminal 121 and the second terminal 122, e.g., a switch 123 and a switch 124. The number of switches in the high voltage side circuit 12 is not limited by the example of FIG. 1. In another embodiment, the high voltage side circuit 12 may also comprise more than two switches coupled in series between the first terminal 121 and the second terminal 122. The first terminal 121 of the high voltage side circuit 12 is coupled to the voltage terminal 101 via the protection switch 11. The low voltage side circuit 13 is coupled to the voltage terminal 103 and the voltage return terminal 104. The low voltage side circuit 13 comprises at least one switch 131 coupled between the second terminal 122 of the high voltage side circuit 12 and the voltage return terminal 104. In another embodiment, the low voltage side circuit 13 may also comprise a plurality of switches coupled between the second terminal 122 of the high voltage side circuit 12 and the voltage return terminal 104. In one embodiment, the switch 131 may be coupled to the second terminal 122 of the high voltage side circuit 12 directly or be coupled to the second terminal 122 of the high voltage side circuit 12 via other components. With the non-isolated switching converter 20 in FIG. 1 working as an intermediate power converter, the power supply system 100 may have higher conversion efficiency and power density, and can be flexibly used in applications where a reverse power supply (e.g., from the voltage terminal 103 to the voltage terminal 101) is required, providing high reliability.

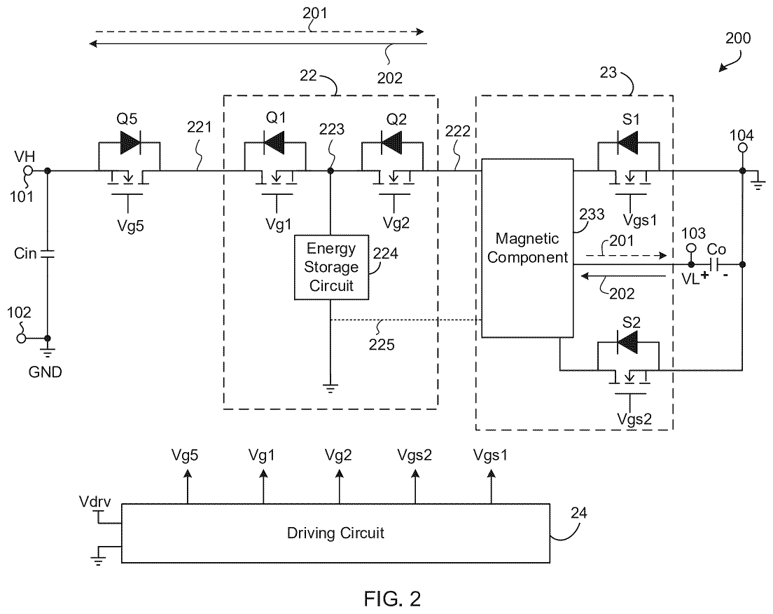

FIG. 2 schematically shows a circuit diagram of a non-isolated switching converter 200 in accordance with an embodiment of the present invention. In the embodiment of FIG. 2, the non-isolated switching converter 200 has a protection switch Q5, a high voltage side circuit 22, and a low voltage side circuit 23. When the non-isolated switching converter 200 operates in the forward mode, the voltage terminal 101 receives the voltage VH, the voltage terminal 103 provides the voltage VL which is lower than the voltage VH, and a current flows from the voltage terminal 101 to the voltage terminal 103, as shown by a dashed line 201. When the non-isolated switching converter 200 operates in the reverse mode, the voltage terminal 101 provides the voltage VH, the voltage terminal 103 receives the voltage VL, and the current flows from the voltage terminal 103 to the voltage terminal 101, as shown by a solid line 202. In one embodiment, a capacitor Cin is coupled between the voltage terminal 101 and the voltage return terminal 102 to stabilize the voltage VH, and a capacitor Co is coupled between the voltage terminal 103 and the voltage return terminal 104 to stabilize the voltage VL.

In the embodiment of FIG. 2, the high voltage side circuit 22 has a first terminal 221, a second terminal 222, and switches Q1-Q2 coupled in series between the first terminal 221 and the second terminal 222. The first terminal 221 of the high voltage side circuit 22 is coupled to the voltage terminal 101 via the protection switch Q5. One with ordinary skill in the art should understand that in some embodiments, the switches Q1-Q2 and the protection switch Q5 may comprise controllable switches like metal oxide semiconductor field transistors (MOSFETs), Junction Field Effect Transistors (JFETs), Bipolar Junction Transistors (BJT), Super Junction Transistors (SJTs), and Insulated Gate Bipolar Transistors (IGBTs), etc. In one embodiment, the protection switch Q5 and the switch Q1 are coupled in a back-to-back manner, e.g., a drain terminal of the protection switch Q5 and a drain terminal of the switch Q1 are coupled together, so that a cathode of a parasitic diode of the protection switch Q5 faces a cathode of a parasitic diode of the switch Q1.

In one embodiment, a source terminal of the protection switch Q5 is coupled to the voltage terminal 101 and the drain terminal of the protection switch Q5 is coupled to the drain terminal of the switch Q1. A source terminal of the switch Q1 is coupled to a drain terminal of the switch Q2 to form a common node 223 of the switch Q1 and the switch Q2. A source terminal of the switch Q2, which is also the second terminal 222 of the high voltage side circuit 22, is coupled to the low voltage side circuit 23. In one embodiment, the high voltage side circuit further has an energy storage circuit 224. The energy storage circuit 224 has a first terminal coupled to the common node 223 of the switches Q1 and Q2 and a second terminal coupled to the reference ground GND and/or the low voltage side circuit 23 (as shown by the dashed line 225 in FIG. 2). In another embodiment, the second terminal of the energy storage circuit 224 may also be coupled to the voltage terminal 101 via other components or devices. In some embodiments, the energy storage circuit 224 may comprise a capacitor, or a resonant tank formed by at least a capacitor and an inductor. In another embodiment, the high voltage side circuit may comprise a plurality of energy storage circuits.

The low voltage side circuit 23 is coupled to the voltage terminal 103 and the voltage return terminal 104, and provides or receives the voltage VL between the voltage terminal 103 and the voltage return terminal 104. In one embodiment, when the non-isolated switching converter 200 operates in the forward mode, the low voltage side circuit 23 works as a rectifier circuit. For example, the low voltage side circuit 23 may be a half-wave rectifying circuit, a full-wave rectifying circuit with a center tap, or a full-bridge rectifying circuit. In the example of FIG. 2, the low voltage side circuit has a magnetic component 233, a switch S1, and a switch S2. In some embodiments, the magnetic component 233 may be a magnetic component comprising a winding and a magnetic core (e.g., a transformer, an inductor, etc.). In another embodiment, the magnetic component 233 may be replaced by a capacitor. One with ordinary skill in the art should understand that the detailed circuit structure of the low voltage side circuit is not limited by the example shown in FIG. 2. The switches S1 and S2 of the low voltage side circuit 23 may also be directly connected to the high voltage side circuit 22 without the magnetic component 233. In one embodiment, the low voltage side circuit 23 may not include the magnetic component 233.

In one embodiment, both the switch S1 and the switch S2 are coupled between the magnetic component 233 and the voltage return terminal 104. In one embodiment, the switch S1 may be coupled to the second terminal 222 of the high voltage side circuit 22 via the magnetic component 233, or be coupled to the second terminal 222 of the high voltage side circuit 22 directly. In the embodiment of FIG. 2, the switches S1 and S2 are controllable switches with control terminals, e.g., MOSFET, JFET, BJT, SJT, and IGBT, etc.

In one embodiment, the non-isolated switching converter 200 further has a driving circuit 24 which provides driving signals to the switches Q1-Q2, the switches S1-S2, and the protection switch Q5. For example, the driving circuit 24 provides a driving signal Vg1 to a gate terminal of the switch Q1 to drive the switch Q1, provides a driving signal Vg2 to a gate terminal of the switch Q2 to drive the switch Q2, provides a driving signal Vg5 to a gate terminal of the switch Q5 to drive the switch Q5, provides a driving signal Vgs1 to a gate terminal of the switch S1 to drive the switch S1, and provides a driving signal Vgs2 to a gate terminal of the switch S2 to drive the switch S2. In one embodiment, the driving circuit 24 has a positive power supply terminal coupled to a supply voltage Vdrv and a negative power supply terminal coupled to the reference ground GND.

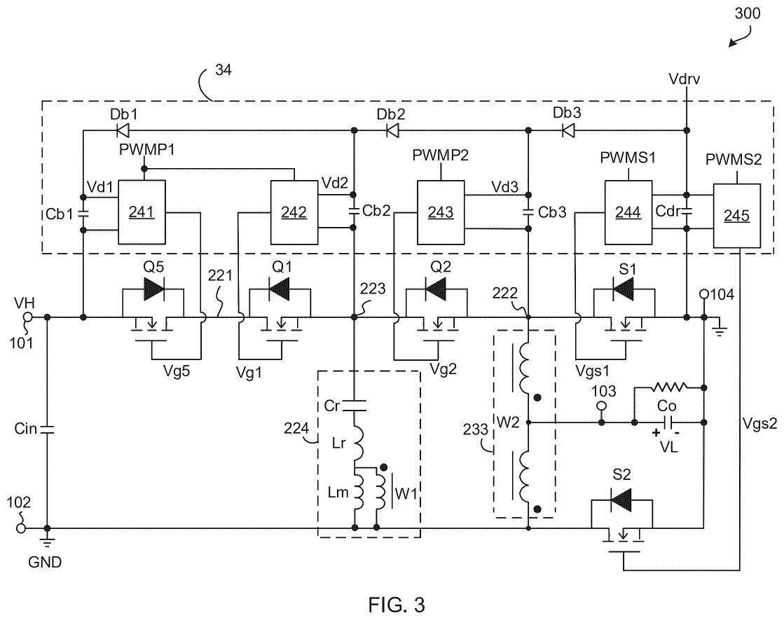

FIG. 3 schematically shows a circuit diagram of a non-isolated switching converter 300 in accordance with an embodiment of the present invention. The non-isolated switching converter 300 has a high voltage side circuit, a low voltage side circuit, and a driving circuit 34, wherein the high voltage side circuit comprises the protection switch Q5, the switches Q1-Q2, and the energy storage circuit 224, and the low voltage side circuit comprises the switches S1-S2 and the magnetic component 233. In the embodiment of FIG. 3, the energy storage circuit 224 has a resonant tank formed by a resonant inductor Lr, a magnetic inductor Lm of a primary winding W1 of a transformer, and a resonant capacitor Cr. In one embodiment, the resonant inductor Lr may be implemented by a leakage inductor of the primary winding W1 of the transformer. One with ordinary skill in the art should understand that the detailed circuit structure of the energy storage circuit 224 is not limited by the embodiment of FIG. 3, and the energy storage circuit 224 may also comprise other types of resonant tanks, e.g., a resonant tank formed by one resonant inductor and one resonant capacitor, a resonant tank formed by one resonant inductor and two resonant capacitors, or a resonant tank formed by a plurality of resonant inductors and a plurality of resonant capacitors, etc. In the embodiment of FIG. 3, the energy storage circuit 224 has one terminal coupled to the common node 223 of the switches Q1 and Q2, and has another terminal coupled to the reference ground GND. In one embodiment, the magnetic component 233 may comprise a secondary winding W2 of the transformer. In the example of FIG. 3, the secondary winding W2 has one end coupled to a common node of the switches S1 and Q2, and has another end coupled to the switch S2 and the reference ground GND, and a center tap of the secondary winding W2 is coupled to the voltage terminal 103 to provide or receive the voltage VL.

In one embodiment, the driving circuit 34 has a positive power supply terminal coupled to the supply voltage Vdrv and a negative power supply terminal coupled to the reference ground GND. In the example of FIG. 3, the driving circuit 34 has a driver 241 to provide the driving signal Vg5 for driving the switch Q5, and has a driver 242 to provide the driving signal Vg1 for driving the switch Q1. The driver 241 is coupled to both ends of a bootstrap capacitor Cb1, and a voltage Vd1 across the bootstrap capacitor Cb1 provides power to the driver 241. In one embodiment, one end of the bootstrap capacitor Cb1 is coupled to the voltage terminal 101, e.g., the source terminal of the switch Q5, and another end of the bootstrap capacitor Cb1 is coupled to a charging circuit which charges the bootstrap capacitor Cb1, for example but not limited to, a charging switch Db1 and a bootstrap capacitor Cb2 shown in FIG. 3. In another embodiment, the charging circuit for charging the bootstrap capacitor Cb1 may also comprise a charge pump circuit. The driver 242 is coupled to both ends of the bootstrap capacitor Cb2, and a voltage Vd2 across the bootstrap capacitor Cb2 provides power to the driver 242. In one embodiment, a first end of the bootstrap capacitor Cb2 is coupled to the common node 223 of the switch Q1 and the switch Q2, and a second end of the bootstrap capacitor Cb2 is coupled to the bootstrap capacitor Cb1 via the charging switch Db1. When the protection switch Q5 and the switch Q1 are turned on, the bootstrap capacitor Cb2 charges the bootstrap capacitor Cb1 via the charging switch Db1. When a voltage across the bootstrap capacitor Cb1 is not sufficient to turn on the protection switch Q5, a current charging the bootstrap capacitor Cb1 flows through the parasitic diode of the protection switch Q5 and flows through the switch Q1. The second end of the bootstrap capacitor Cb2 is further coupled to a charging circuit which charges the bootstrap capacitor Cb2, for example but not limited to, a charging switch Db2 and the bootstrap capacitor Cb3 shown in FIG. 3. When the switch Q2 is turned on, the bootstrap capacitor Cb3 charges the bootstrap capacitor Cb2 via the charging switch Db2. In another embodiment, the charging circuit for charging the bootstrap capacitor Cb2 may also comprise a charge pump circuit. In one embodiment, the driver 241 and the driver 242 receive the control signal PWMP1, and provide the driving signals Vg5 and Vg1 respectively based on the control signal PWMP1, so that the protection switch Q5 and the switch Q1 are synchronously turned on and off under the control of the control signal PWMP1. One with ordinary skill in the art should understand that in some embodiments, there may be a delay between the synchronous turning on and turning off of the protection switch Q5 and the switch Q1.

In the embodiment of FIG. 3, the driving circuit 34 further comprises a driver 243 which provides the driving signal Vg2 to the switch Q2 and a driver 244 which provides the driving signal Vgs1 to the switch S1. The driver 243 is coupled to both ends of the bootstrap capacitor Cb3, and a voltage Vd3 across the bootstrap capacitor Cb3 provides power to the bootstrap capacitor Cb3. In one embodiment, a first end of the bootstrap capacitor Cb3 is coupled to the source terminal of the switch Q2, and a second end of the bootstrap capacitor Cb3 is coupled to a charging circuit which charges the bootstrap capacitor Cb3, for example but not limited to, the switch Db3 and the supply voltage Vdrv shown in FIG. 3. In the embodiment of FIG. 3, the second end of the bootstrap capacitor Cb3 is further coupled to the bootstrap capacitor Cb2 via the charging switch Db2. When the switch S1 is turned on, the supply voltage Vdrv charges the bootstrap capacitor Cb3 via the charging switch Db3. In another embodiment, the charging circuit for charging the bootstrap capacitor Cb3 may also comprise a charge pump circuit. In one embodiment, the driver 243 receives the control signal PWMP2 and provides the driving signal Vg2 based on the control signal PWMP2, so that the switch Q2 is turned on and off under the control of the control signal PWMP2. In one embodiment, the control signal PWMP1 and the control signal PWMP2 are complementary in phase to turn on and off the switch Q2 and the switch Q1 in a complementary manner. One with ordinary skill in the art should understand that to prevent the switch Q2 and the switch Q1 from being on at the same time, there may be a dead time between the driving signal Vg2 and the driving signal Vg1. The driver 244 receives the supply voltage Vdrv as its driving power supply. In one embodiment, a capacitor Cdr is coupled between the supply voltage Vdrv and the reference ground GND, and both ends of the capacitor Cdr are coupled to the driver 244 to provide a stable power supply for the driver 244. In one embodiment, the driver 244 receives a control signal PWMS1 and provides the driving signal Vgs1 based on the control signal PWMS1 to turn on and off the switch S1. In one embodiment, the control signal PWMS1 and the control signal PWMP2 may be complementary in phase to turn on and off the switch S1 and the switch Q1 in the complementary manner. One with ordinary skill in the art should understand that to prevent the switch S1 and the switch Q1 from being on at the same time, there may be a dead time between the driving signal Vgs1 and the driving signal Vg1. In the embodiment of FIG. 3, the driving circuit 34 further has a driver 245 providing the driving signal Vgs2 to the switch S2. The driver 245 receives the supply voltage Vdrv as its driving power supply. In one embodiment, the driver 245 receives a control signal PWMS2 and provides the driving signal Vgs2 based on the control signal PWMS2 to turn on and off the switch S2. In one embodiment, the control signal PWMS1 and the control signal PWMS2 are complementary in phase to turn on and off the switch S2 and the switch S1 in the complementary manner. One with ordinary skill in the art should understand that to prevent the switch S1 and the switch S2 from being on at the same time, there may be a dead time between the driving signal Vgs1 and the driving signal Vgs2. In some embodiments, the charging switches Db1-Db3 may comprise diodes or controllable switches (e.g., MOSFET, JFET, BJT, SJT, and IGBT), etc. In one embodiment, the driving circuit 34 may be integrated in one or more driving integrated circuits (ICs).

The driving circuit 34 for non-isolated switching converters provided in the embodiments of the present invention charges the bootstrap capacitor Cb1 via the bootstrap capacitor Cb2 when the switch Q1 is turned on, which provides power supply required for driving the protection switch Q5 in a simple way, thus ensuring stability and reliable of the system. Especially when the voltage across the bootstrap capacitor Cb1 is not sufficient to drive the protection switch Q5, the bootstrap capacitor Cb2 is configured to charge the bootstrap capacitor Cb1 via the parasitic diode of the protection switch Q5, the switch Q1, and the charging switch Db1.

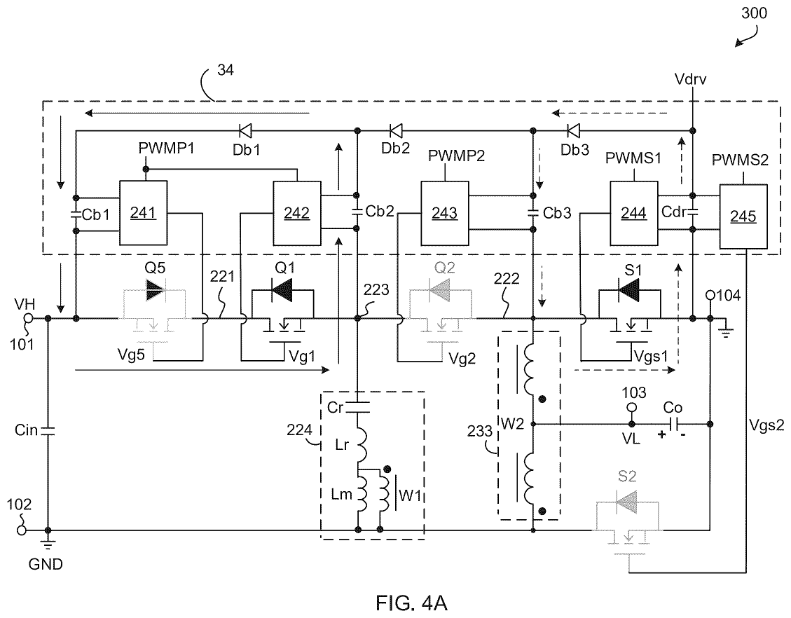

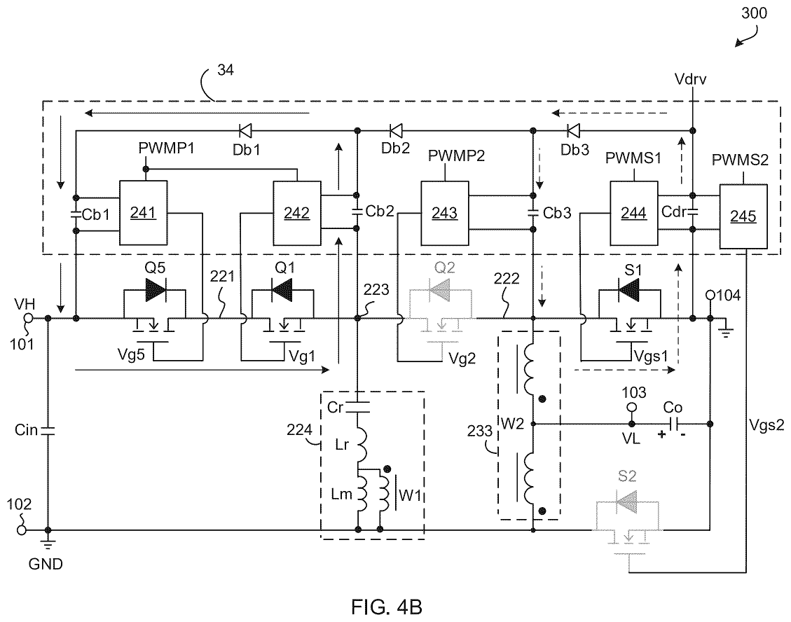

FIG. 4A schematically shows the non-isolated switching converter 300 working in a first switching mode in accordance with an embodiment of the present invention. In the embodiment of FIG. 4A, in the first switching mode, the switch Q1 and the switch S1 are turned on, and the switch Q2 and the switch S2 are turned off. Since the switch S1 is on, the supply voltage Vdrv charges the bootstrap capacitor Cb3 via the charging switch Db3, a voltage across the bootstrap capacitor Cb3 increases, and a current flows back to the reference ground GND and the capacitor Cdr via the switch S1. A current loop for charging the bootstrap capacitor Cb3 is shown by dashed lines with arrows in FIG. 4A. In the embodiment of FIG. 4A, when the voltage across the bootstrap capacitor Cb1 is insufficient to supply the driver 241 for providing the driving signal Vg5, the protection switch Q5 is off. Before the protection switch Q5 is turned on, the bootstrap capacitor Cb2 charges the bootstrap capacitor Cb1 via the charging switch Db1 when the switch Q1 is on. The voltage across the bootstrap capacitor Cb1 increases, and the current charging the bootstrap capacitor Cb1 flows back to the bootstrap capacitor Cb2 via the parasitic diode of the protection switch Q5 and via the switch Q1. A current loop for charging the bootstrap capacitor Cb1 in the first switching mode is shown by solid lines with arrows in FIG. 4A. In one embodiment, when the voltage across the bootstrap capacitor Cb1 is sufficient to turn on the protection switch Q5, the non-isolated switching converter 300 enters a second switching mode.

FIG. 4B schematically shows the non-isolated switching converter 300 working in the second switching mode in accordance with an embodiment of the present invention. In the embodiment of FIG. 4B, in the second switching mode, the protection switch Q5, the switch Q1, and the switch S1 are turned on, and the switch Q2 and the switch S2 are turned off. Since the switch Q1 and the protection switch Q5 are on, the bootstrap capacitor Cb2 charges the bootstrap capacitor Cb1 via the charging switch Db1, the voltage across the bootstrap capacitor Cb1 increases, and a current flows back to the bootstrap capacitor Cb2 via the protection switch Q5 and the switch Q1. A current loop for charging the bootstrap capacitor Cb1 in the second switching mode is shown by solid lines with arrows in FIG. 4B.

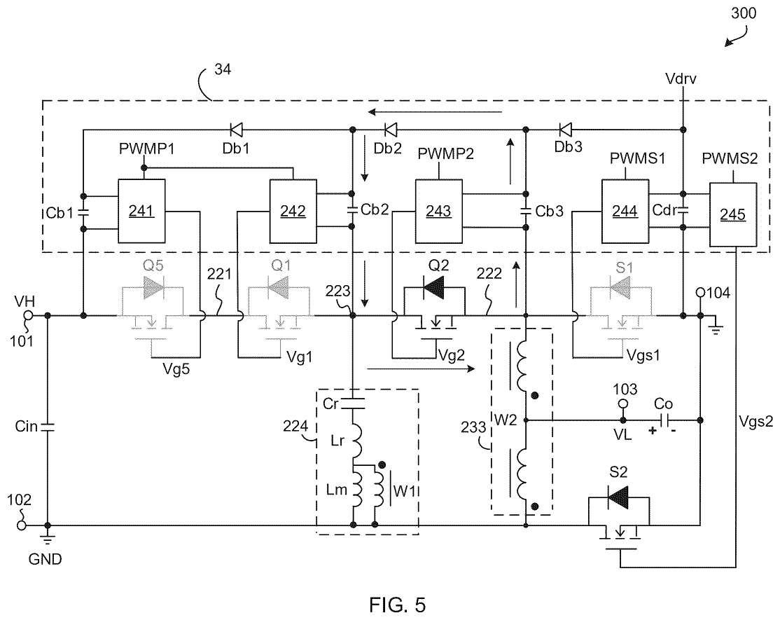

FIG. 5 schematically shows the non-isolated switching converter 300 working in a third switching mode in accordance with an embodiment of the present invention. As shown in FIG. 5, in the third switching mode, the protection switch Q5, the switch Q1, and the switch S1 are turned off, and the switch Q2 and the switch S2 are turned on. Since the switch Q2 is on, the bootstrap capacitor Cb3 charges the bootstrap capacitor Cb2 via the charging switch Db2, a voltage across the bootstrap capacitor Cb2 increases, and a current flows back to the bootstrap capacitor Cb3 via the switch Q2. A current loop for charging the bootstrap capacitor Cb2 in the third switching mode is shown by solid lines with arrows in FIG. 5.

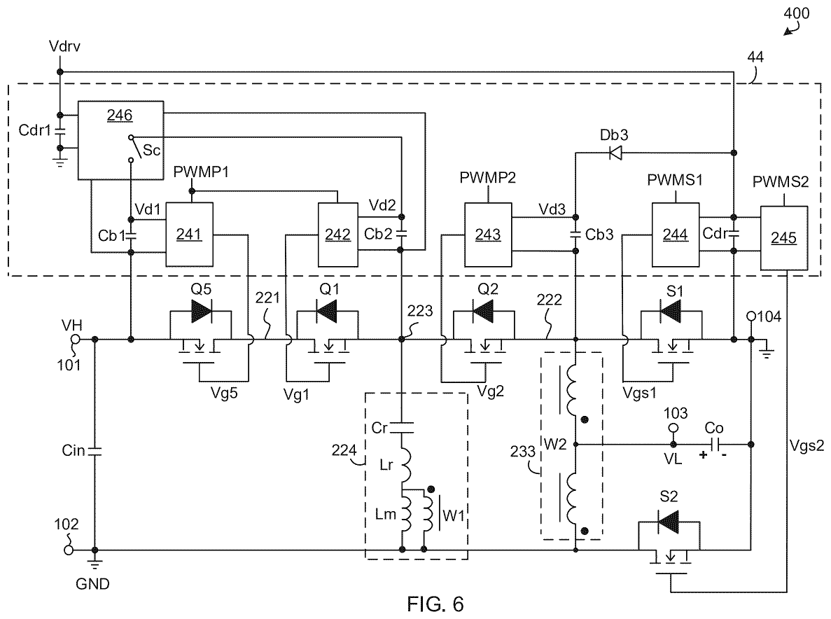

FIG. 6 schematically shows a circuit diagram of a non-isolated switching converter 400 in accordance with an embodiment of the present invention. The non-isolated switching converter 400 has a high voltage side circuit formed by the protection switch Q5, the switch Q1, the switch Q2, and the energy storage circuit 224, a low voltage side circuit formed by S1, S2, and the magnetic component 233, and a driving circuit 44. In the embodiment of FIG. 6, the driving circuit 44 has a charging circuit 246 which charges the bootstrap capacitor Cb1 and the bootstrap capacitor Cb2. As shown in FIG. 6, the charging circuit 246 is coupled to both ends of a capacitor Cdr1 to receive the supply voltage Vdrv. The charging circuit 246 provides the voltage Vd1 across the bootstrap capacitor Cb1, and provides the voltage Vd2 across the bootstrap capacitor Cb2. In one embodiment, the supply voltage Vdrv charges the bootstrap capacitor Cb2 via the charging circuit 246. In one embodiment, the charging circuit 246 comprises a charging switch Sc coupled between the bootstrap capacitor Cb1 and the bootstrap capacitor Cb2. When the protection switch Q5 and the switch Q1 are turned on, the charging switch Sc is turned on, and the bootstrap capacitor Cb2 charges the bootstrap capacitor Cb1 via the charging switch Sc. In one embodiment, the driving circuit 44 is integrated in one or more driving ICs.

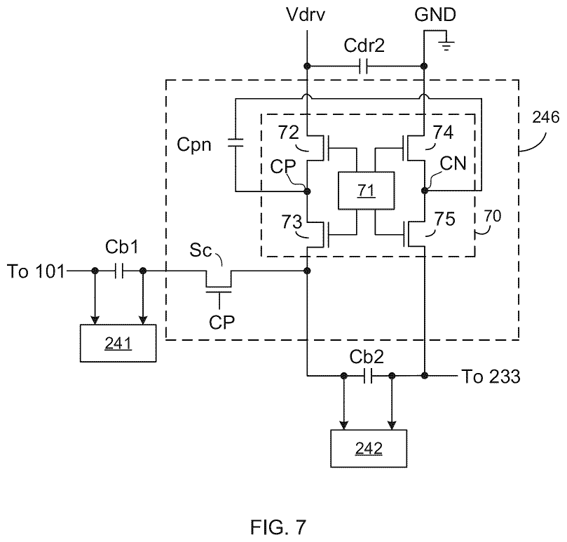

FIG. 7 schematically shows a circuit diagram of the charging circuit 246 in accordance with an embodiment of the present invention. One with ordinary skill in the art should understand that the detailed structure of the charging circuit 246 is not limited by the example of FIG. 7. In the embodiment of FIG. 7, the charging circuit 246 has a charge pump circuit 70 formed by switches 72-75 and an oscillator 71, the charging switch Sc, and a flying capacitor Cpn. The switch 72 has one terminal coupled to the supply voltage Vdrv and another terminal coupled to one terminal of the switch 73, and another terminal of the switch 73 is coupled to one end of the bootstrap capacitor Cb2 and the charging switch Sc. the switch 74 has one terminal coupled to the reference ground GND and another terminal coupled to one terminal of the switch 75, and another terminal of the switch 75 is coupled to another end of the bootstrap capacitor Cb2. A common node of the switch 72 and the switch 73 is coupled to a charge pump pin CP, and a common node of the switch 74 and the switch 75 is coupled to a charge pump pin CN. In some embodiments, the switches 72-75 may comprise MOSFET, JFET, BJT, SJT, and IGBT, etc.

In one embodiment, the switch 72 and the switch 74 are turned on at a certain frequency under the control of the oscillator 71 to charge the flying capacitor Cpn, e.g., the supply voltage Vdrv charges the flying capacitor Cpn via the switch 72 and the switch 74. When the switch 72 and the switch 74 are off, the switch 73 and the switch 75 are turned on at a certain frequency under the control of the oscillator 71 to charge the bootstrap capacitor Cb2, e.g., the flying capacitor Cpn charges the bootstrap capacitor Cb2 via the switch 73 and the switch 75. In one embodiment, when the protection switch Q5 and the switch Q1 are on, the charging switch Sc is turned on, the bootstrap capacitor Cb2 charges the bootstrap capacitor Cb1 via the protection switch Q5, the switch Q1, and the charging switch Sc.

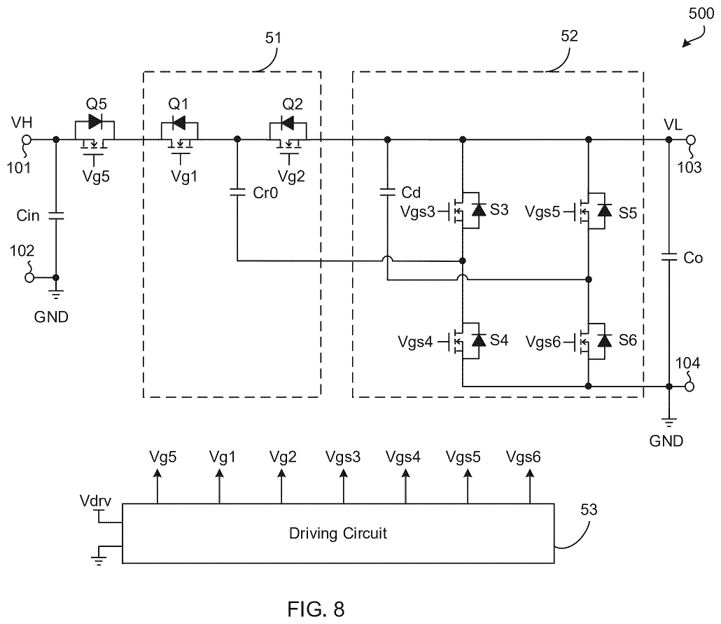

FIG. 8 schematically shows a circuit diagram of a non-isolated switching converter 500 in accordance with an embodiment of the present invention. In the embodiment of FIG. 8, the non-isolated switching converter 500 has the protection switch Q5, a high voltage side circuit 51, a low voltage side circuit 52, and a driving circuit 53, wherein the high voltage side circuit 51 comprises the switches Q1-Q2, and an energy storage circuit Cr0, and the low voltage side circuit 52 comprises switches S3-S6 and an energy storage circuit Cd. In the embodiment of FIG. 8, the energy storage circuit Cr0 and the energy storage circuit Cd comprise at least a capacitor respectively. When the non-isolated switching converter 500 operates in the forward mode, the voltage terminal 101 receives the voltage VH, the voltage terminal 103 provides the voltage VL which is lower than the voltage VH, and a current flows from the voltage terminal 101 to the voltage terminal 103. When the non-isolated switching converter 500 operates in the reverse mode, the voltage terminal 101 provides the voltage VH, the voltage terminal 103 receives the voltage VL, and a current flows from the voltage terminal 103 to the voltage terminal 101.

The driving circuit 53 provides driving signals to the switches of the non-isolated switching converter 500, e.g., providing the driving signal Vg1 to the gate terminal of the switch Q1 to drive the switch Q1, providing the driving signal Vg2 to the gate terminal of the switch Q2 to drive the switch Q2, providing the driving signal Vg5 to the gate terminal of the protection switch Q5 to drive the protection switch Q5, providing a driving signal Vgs3 to the gate terminal of the switch S3 to drive the switch S3, providing a driving signal Vgs4 to the gate terminal of the switch S4 to drive the switch S4, providing a driving signal Vgs5 to the gate terminal of the switch S5 to drive the switch S5, and providing a driving signal Vgs6 to the gate terminal of the switch S6 to drive the switch S6. In one embodiment, the driving circuit 53 comprises a positive power supply terminal coupled to the supply voltage Vdrv and a negative power supply terminal coupled to the reference ground GND. The driving circuit 53 has a detailed circuit structure similar to that of the driving circuit 34 or the driving circuit 44, which is not described here for brevity.

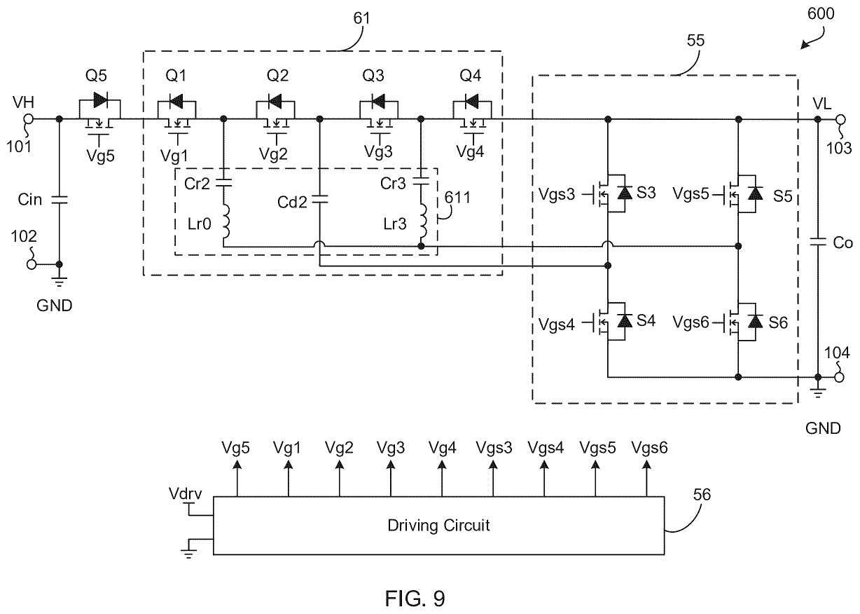

FIG. 9 schematically shows a circuit diagram of a non-isolated switching converter 600 in accordance with an embodiment of the present invention. In the embodiment of FIG. 9, the non-isolated switching converter 600 comprises the protection switch Q5, a high voltage side circuit 61, a low voltage side circuit 55, and a driving circuit 56, wherein the high voltage side circuit 61 comprises the switches Q1-Q2, switches Q3-Q4, and an energy storage circuit 611, and the low voltage side circuit 55 comprises the switches S3-S6. In the example of FIG. 9, the energy storage circuit 611 comprises a resonant tank formed by a capacitor Cr2 and an inductor Lr0, a resonant tank formed by a capacitor Cr33 and an inductor Lr3, and a capacitor Cd2. When the non-isolated switching converter 600 operates in the forward mode, the voltage terminal 101 receives the voltage VH, the voltage terminal 103 provides the voltage VL which is lower than the voltage VH, and a current flows from the voltage terminal 101 to the voltage terminal 103. When the non-isolated switching converter 600 operates in the reverse mode, the voltage terminal 101 provides the voltage VH, the voltage terminal 103 receives the voltage VL, and a current flows from the voltage terminal 103 to the voltage terminal 101.

The driving circuit 56 provides driving signals to the switches of the non-isolated switching converter 600, e.g., providing the driving signal Vg1 to the gate terminal of the switch Q1 to drive the switch Q1, providing the driving signal Vg2 to the gate terminal of the switch Q2 to drive the switch Q2, providing a driving signal Vg3 to the gate terminal of the switch Q3 to drive the switch Q3, providing a driving signal Vg4 to the gate terminal of the switch Q4 to drive the switch Q4, providing the driving signal Vg5 to the gate terminal of the protection switch Q5 to drive the protection switch Q5, providing the driving signal Vgs3 to the gate terminal of the switch S3 to drive the switch S3, providing the driving signal Vgs4 to the gate terminal of the switch S4 to drive the switch S4, providing the driving signal Vgs5 to the gate terminal of the switch S5 to drive the switch S5, and providing the driving signal Vgs6 to the gate terminal of the switch S6 to drive the switch S6. In one embodiment, the driving circuit 56 has a positive power supply terminal coupled to the supply voltage Vdrv and a negative power supply terminal coupled to the reference ground GND. The driving circuit 56 has a detailed structure similar to that of the driving circuit 34 or the driving circuit 44, which is not described here for brevity.

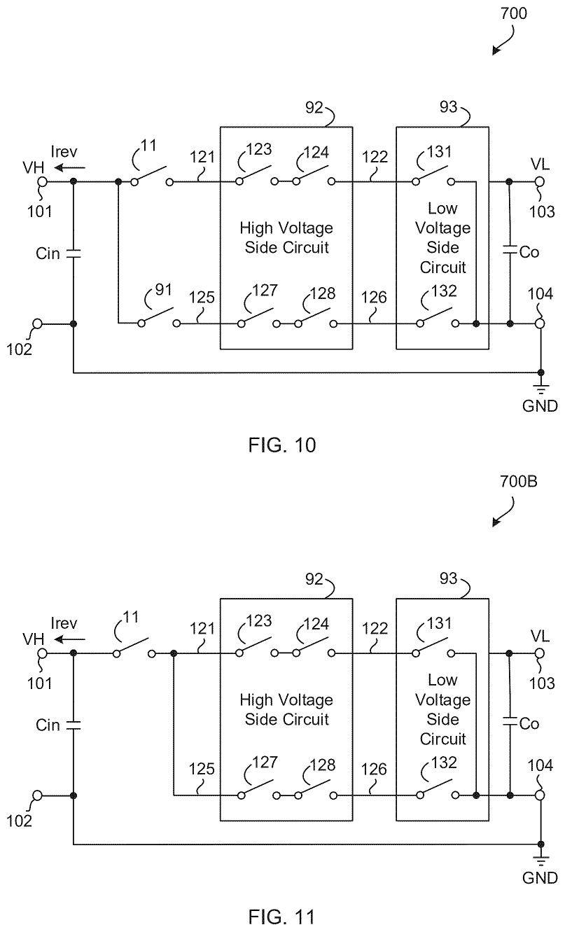

FIG. 10 schematically shows a circuit diagram of a non-isolated switching converter 700 in accordance with an embodiment of the present invention. In the embodiment of FIG. 10, the non-isolated switching converter 700 has the voltage terminal 101, the voltage return terminal 102, the voltage terminal 103, the voltage return terminal 104, the protection switch 11, a protection switch 91, a high voltage side circuit 92, and a low voltage side circuit 93. When the voltage terminal 101 is shorted to the reference ground, the protection switches 11 and 91 are configured to prevent the current Irev flowing to the voltage terminal 101 from being too large, so that to prevent the non-isolated switching converter 700 from damage caused by a short circuit at the voltage terminal 101 when in the reverse mode. When the non-isolated switching converter 700 operates in the forward mode, the voltage terminal 101 receives the voltage VH, the voltage terminal 103 provides the voltage VL which is lower than the voltage VH, and a current flows from the voltage terminal 101 to the voltage terminal 103. When the non-isolated switching converter 700 operates in the reverse mode, the voltage terminal 101 provides the voltage VH, the voltage terminal 103 receives the voltage VL, and a current flows from the voltage terminal 103 to the voltage terminal 101.

The high voltage side circuit 92 has the first terminal 121, the second terminal 122, a third terminal 125, a fourth terminal 126, the at least two switches 123-124 coupled in series between the first terminal 121 and the second terminal 122, and at least two switches 127-128 coupled in series between the third terminal 125 and the fourth terminal 126. The first terminal 121 of the high voltage side circuit 92 is coupled to the voltage terminal 101 via the protection switch 11, and the third terminal 125 of the high voltage side circuit 92 is coupled to the voltage terminal 101 via the protection switch 91. The number of switches coupled between the first terminal 121 and the second terminal 122 and the number of switches coupled between the third terminal 125 and the fourth terminal 126 are not limited by the example of FIG. 10. In another embodiment, the high voltage side circuit 92 may also comprise more than two switches coupled in series between the first terminal 121 and the second terminal 122. In yet another embodiment, the high voltage side circuit 92 may also comprise more than two switches coupled in series between the third terminal 125 and the fourth terminal 126.

The low voltage side circuit 93 is coupled to the voltage terminal 103 and the voltage return terminal 104. The low voltage side circuit 93 comprises the at least one switch 131 coupled between the second terminal 122 of the high voltage side circuit 92 and the voltage return terminal 104, and at least one switch 132 coupled between the fourth terminal 126 of the high voltage side circuit 92 and the voltage return terminal 104. In other embodiments, the low voltage side circuit 93 may also comprise a plurality of switches coupled between the second terminal 122 of the high voltage side circuit 92 and the voltage return terminal 104, and may also comprise a plurality of switches coupled between the fourth terminal 126 of the high voltage side circuit 92 and the voltage return terminal 104. In one embodiment, the switch 131 may be coupled to the second terminal 122 of the high voltage side circuit 92 directly or be coupled to the second terminal 122 of the high voltage side circuit 92 via other components, and the switch 132 may be coupled to the fourth terminal 126 of the high voltage side circuit 92 directly or be coupled to the fourth terminal 126 of the high voltage side circuit 92 via other components.

FIG. 11 schematically shows a circuit diagram of a non-isolated switching converter 700B in accordance with an embodiment of the present invention. In the embodiment of FIG. 11, both the first terminal 121 and the third terminal 125 of the high voltage side circuit 92 are coupled to the voltage terminal 101 via the protection switch 11, which is different from the non-isolated switching converter 700 shown in FIG. 10.

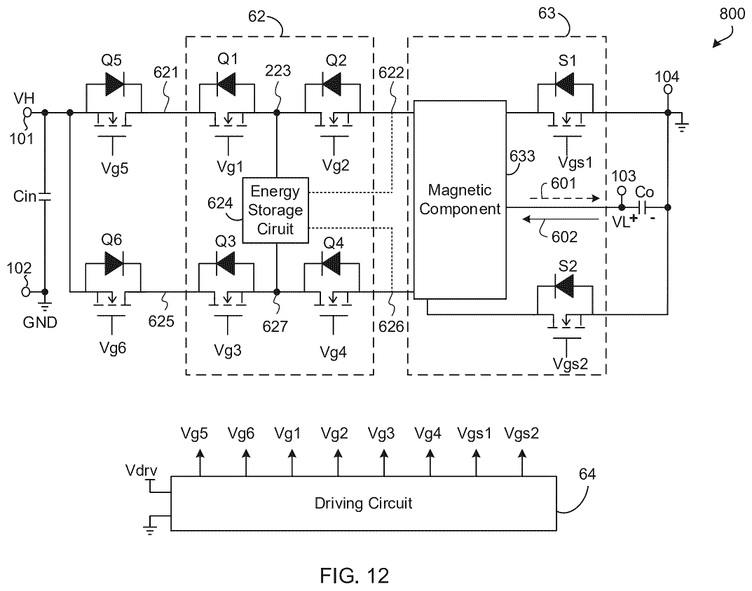

FIG. 12 schematically shows a circuit diagram of a non-isolated switching converter 800 in accordance with an embodiment of the present invention. The non-isolated switching converter 800 has the voltage terminal 101, the voltage return terminal 102, the voltage terminal 103, the voltage return terminal 104, the protection switch Q5, a protection switch Q6, a high voltage side circuit 62, and a low voltage side circuit 63. When the non-isolated switching converter 800 operates in the forward mode, the voltage terminal 101 receives the voltage VH, the voltage terminal 103 provides the voltage VL which is lower than the voltage VH, and a current flows from the voltage terminal 101 to the voltage terminal 103, e.g., the current flows to the voltage terminal 103 via the protection switch Q5, the switch Q1, and the switch Q4 successively, and via the protection switch Q6, the switch Q3, and the switch Q2 successively. When the non-isolated switching converter 800 operates in the reverse mode, the voltage terminal 101 provides the voltage VH, the voltage terminal 103 receives the voltage VL, and a current flows from the voltage terminal 103 to the voltage terminal 101, e.g., the current flows to the voltage terminal 101 via the switch Q2, the switch Q3, and the protection switch Q6 successively, and via the switch Q4, the switch Q11, and the protection switch Q5 successively. The protection switch Q5 is coupled between the voltage terminal 101 and the switch Q1, and the protection switch Q6 is coupled between the voltage terminal 101 and the switch Q3. The protection switches Q5 and Q6 are configured to prevent the non-isolated switching converter 800 from damage caused by its internal protection failure when there is a short circuit at the voltage terminal 101. In another embodiment, the switch Q3 may also be coupled to the voltage terminal 101 via the protection switch Q5 and the protection switch Q6 is therefore omitted.

A first terminal 621 of the high voltage side circuit 62 is coupled to the voltage terminal 101 via the protection switch Q5, a second terminal 622 of the high voltage side circuit 62 is coupled to the low voltage side circuit 63, a third terminal 625 of the high voltage side circuit 62 is coupled to the voltage terminal 101 via the protection switch Q6, and a fourth terminal 626 of the high voltage side circuit 62 is coupled to the low voltage side circuit 63. The high voltage side circuit 62 comprises the at least two switches Q1-Q2 coupled in series between the first terminal 621 and the second terminal 622, the at least two switches Q3-Q4 coupled in series between the third terminal 625 and the fourth terminal 626, and an energy storage circuit 624. In one embodiment, a source terminal of the protection switch Q6 is coupled to the voltage terminal 101, and a drain terminal of the protection switch Q6 is coupled to a drain terminal of the switch Q3. A source terminal of the switch Q3 is coupled to a drain terminal of the switch Q4, forming a common terminal 627 of the switches Q3 and Q4. A source terminal of the switch Q4 is configured as a fourth terminal 626 of the high-voltage side circuit 62, which is coupled to the low voltage side circuit 63. In the embodiment of FIG. 12, one terminal of the energy storage circuit 624 is coupled to the common node 223 of the switch Q1 and the switch Q2, and the other terminal of the energy storage circuit 624 is coupled to the common node 627 of the switch Q3 and the switch Q4. In one embodiment, the energy storage circuit 624 may also be coupled to the second terminal 622 of the high voltage side circuit 62, or the fourth terminal 626 of the high voltage side circuit 62, or both the second terminal 622 and the fourth terminal 626 of the high voltage side circuit 62. Similar to the low voltage side circuit 23 shown in FIG. 2, the low voltage side circuit 63 comprises a magnetic component 633, the switch S1, and the switch S2. In one embodiment, the low voltage side circuit 63 may be coupled to the second terminal 622 and the fourth terminal 626 of the high voltage side circuit 62 via the magnetic component 633. In another embodiment, the switches S1 and S2 of the low voltage side circuit 63 may also be directly coupled to the high voltage side circuit 62, for example, the switch S1 is coupled to the second terminal 622 of the high voltage side circuit 62, and the switch S2 is coupled to the fourth terminal 626 of the high voltage side circuit 62.

In one embodiment, the protection switch Q6 and the switch Q3 are coupled in the back-to-back manner, e.g., the drain terminal of the protection switch Q6 and the drain terminal of the switch Q3 are coupled together, so that a cathode of a parasitic diode of the protection switch Q6 faces a cathode of a parasitic diode of the switch Q3. One with ordinary skill in the art should understand that in some embodiments, the switches Q3-Q4 and the protection switch Q6 may comprise MOSFET, JFET, BJT, SJT, and IGBT, etc.

The non-isolated switching converter 800 further has a driving circuit 64. The driving circuit 64 is coupled between the supply voltage Vdrv and the reference ground GND, and is configured to provide the driving signals Vg1-Vg5 and Vgs1-Vgs2, and a driving signal Vg6 to respectively drive the switches of the non-isolated switching converter 800.

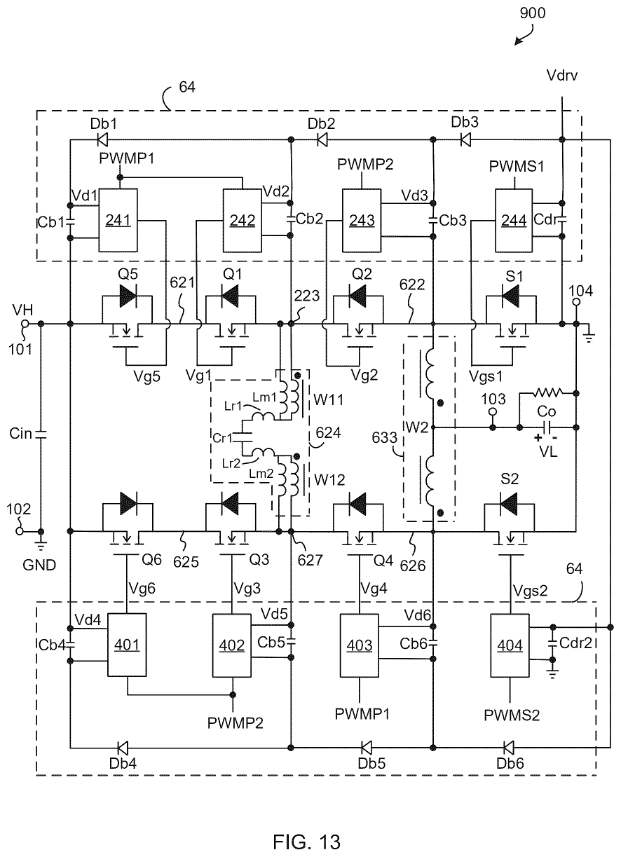

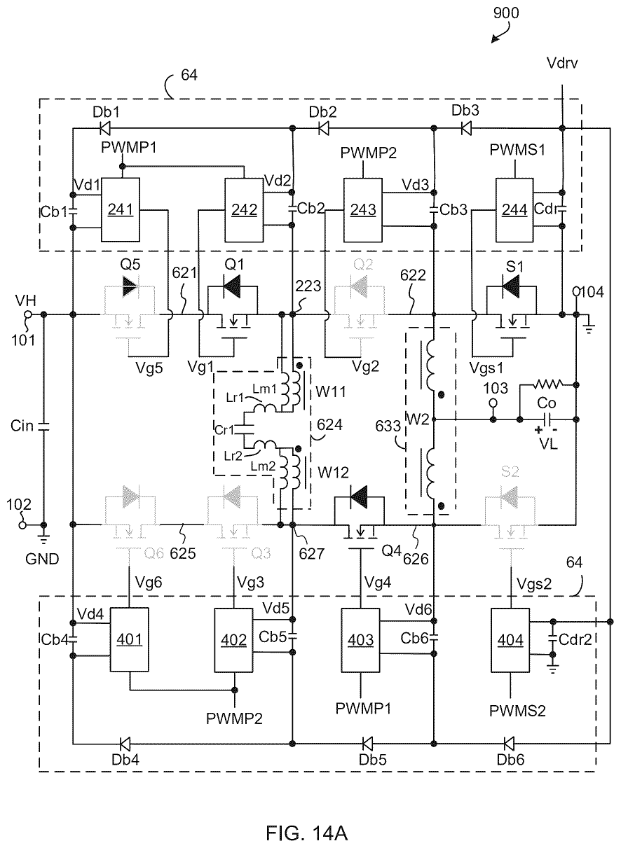

FIG. 13 schematically shows a circuit diagram of a non-isolated switching converter 900 in accordance with an embodiment of the present invention. The non-isolated switching converter 900 has a high voltage side circuit, a low voltage side circuit, and the driving circuit 64, wherein the high voltage side circuit has the protection switch Q5, the protection switch Q6, the switches Q1-Q4, and the low voltage side circuit has the switches S1-S2 and the magnetic component 633.

In the embodiment of FIG. 13, the energy storage circuit 624 comprises a resonant tank formed by a resonant inductor Lr1, a magnetic inductance Lm1 of a primary winding W11 of a transformer, a magnetic inductance Lm2 of a primary winding W12 of the transformer, a resonant inductor Lr2, and a resonant capacitor Cr1. A first terminal of the resonant tank is coupled to the common node 223 of the switch Q1 and the switch Q2, and a second terminal of the resonant tank is coupled to the common node 627 of the switch Q3 and the switch Q4. The resonant inductor Lr1 may be implemented, for example, by a leakage inductance of the primary winding W11 of the transformer, and the resonant inductor Lr2 may be formed, for example, by a leakage inductance of the primary winding W12 of the transformer. One with ordinary skill in the art should understand that a detailed circuit structure of the energy storage circuit 624 is not limited by the embodiment shown in FIG. 13.

The driving circuit 64 comprises the drivers 241-244, the bootstrap capacitors Cb1-Cb3, and the charging switches Db1-Db3, which have a detailed circuit structure similar to that of the driving circuit 34 shown in the embodiment of FIG. 3, and are not described here for brevity. In the embodiment FIG. 13, the driving circuit 64 further comprises a driver 401 providing the driving signal Vg6 for the protection switch Q6 and a driver 402 providing the driving signal Vg3 for the switch Q3. The driver 401 is coupled to both ends of a bootstrap capacitor Cb4, and a voltage Vd4 across the bootstrap capacitor Cb4 provides power to the driver 401. In one embodiment, one end of the bootstrap capacitor Cb4 is coupled to the voltage terminal 101, e.g., a source terminal of the switch Q6, and another end of the bootstrap capacitor Cb4 is coupled to a charging circuit which charges the bootstrap capacitor Cb4, for example but not limited to, a charging switch Db4 and a bootstrap capacitor Cb5 shown in FIG. 13. In another embodiment, the charging circuit for charging the bootstrap capacitor Cb4 may also comprise a charge pump circuit. The driver 402 is coupled to both ends of the bootstrap capacitor Cb5, and a voltage Vd5 across the bootstrap capacitor Cb5 provides power to the driver 402. In one embodiment, a first end of the bootstrap capacitor Cb5 is coupled to the common node 627 of the switch Q3 and the switch Q4, and a second end of the bootstrap capacitor Cb5 is coupled to the bootstrap capacitor Cb4 via the charging switch Db4. When the protection switch Q6 and the switch Q3 are turned on, the bootstrap capacitor Cb5 charges the bootstrap capacitor Cb4 via the charging switch Db4. When a voltage across the bootstrap capacitor Cb4 is not sufficient to turn on the protection switch Q6, a current charging the bootstrap capacitor Cb4 flows through the parasitic diode of the protection switch Q6 and flows through the switch Q3. The second end of the bootstrap capacitor Cb5 is further coupled to a charging circuit which charges the bootstrap capacitor Cb5, for example but not limited to, a charging switch Db5 and the bootstrap capacitor Cb6 shown in FIG. 13. When the switch Q4 is turned on, the bootstrap capacitor Cb6 charges the bootstrap capacitor Cb5 via the charging switch Db5. In another embodiment, the charging circuit for charging the bootstrap capacitor Cb5 may also comprise a charge pump circuit. In one embodiment, the driver 401 and the driver 402 receive the control signal PWMP2 and provide the driving signals Vg6 and Vg3 respectively based on the control signal PWMP2, so that the protection switch Q6 and the switch Q3 are synchronously turned on and off under the control of the control signal PWMP2. One with ordinary skill in the art should understand that in some embodiments, there may be a delay between the synchronous turning on and turning off of the protection switch Q6 and the switch Q3.

In the embodiment of FIG. 13, the driving circuit 64 further comprises a driver 403 providing the driving signal Vg4 to the switch Q4 and a driver 404 providing the driving signal Vgs2 to the switch S2. The driver 403 is coupled to both ends of the bootstrap capacitor Cb6, and a voltage Vd6 across the bootstrap capacitor Cb6 provides power to the bootstrap capacitor Cb6. In one embodiment, a first end of the bootstrap capacitor Cb6 is coupled to the source terminal of the switch Q4, and a second end of the bootstrap capacitor Cb6 is coupled to a charging circuit which charges the bootstrap capacitor Cb6, for example but not limited to, a charging switch Db6 and the supply voltage Vdrv shown in FIG. 13. In the embodiment of FIG. 13, the second end of the bootstrap capacitor Cb6 is further coupled to the bootstrap capacitor Cb5 via the charging switch Db5. When the switch S2 is turned on, the supply voltage Vdrv charges the bootstrap capacitor Cb6 via the charging switch Db6. In another embodiment, the charging circuit for charging the bootstrap capacitor Cb6 may also comprise a charge pump circuit. In one embodiment, the driver 403 receives the control signal PWMP1 and provides the driving signal Vg4 based on the control signal PWMP1, so that the switch Q4 is turned on and off under the control of the control signal PWMP1. In one embodiment, the control signal PWMP1 and the control signal PWMP2 are complementary in phase to turn on and off the switch Q4 and the switch Q3 in the complementary manner. One with ordinary skill in the art should understand that to prevent the switch Q4 and the switch Q3 from being on at the same time, there may be a dead time between the driving signal Vg4 and the driving signal Vg3. The driver 404 receives the supply voltage Vdrv as its driving power supply. In one embodiment, a capacitor Cdr2 is coupled between the supply voltage Vdrv and the reference ground GND, and both ends of the capacitor Cdr2 are coupled to the driver 404 to provide a stable power supply for the driver 404. In one embodiment, the driver 404 receives a control signal PWMS2 and provides the driving signal Vgs2 based on the control signal PWMS2 to turn on and off the switch S2. In some embodiments, the charging switches Db4-Db6 may comprise diodes or controllable switches (e.g., MOSFET, JFET, BJT, SJT, and IGBT), etc. In one embodiment, the driving circuit 64 may be integrated in one or more driving ICs.

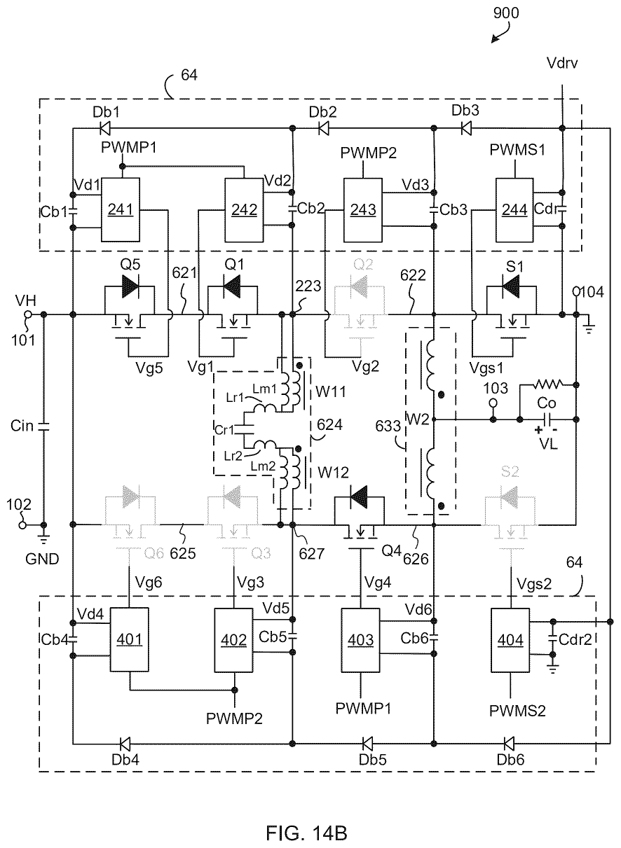

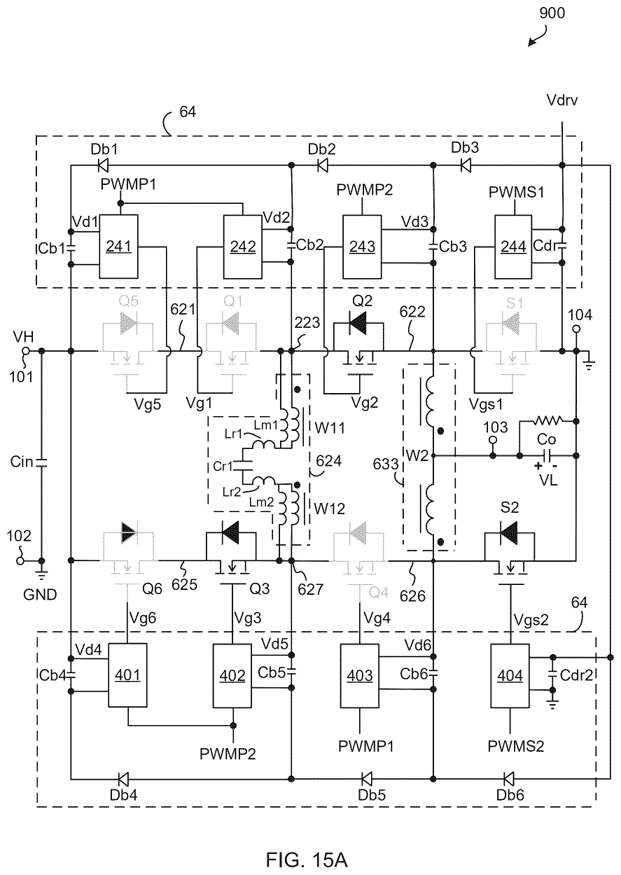

FIG. 14A schematically shows the non-isolated switching converter 900 working in the first switching mode in accordance with an embodiment of the present invention. In the embodiment of FIG. 14A, in the first switching mode, the switch Q1, the switch Q4, and the switch S1 are turned on, and the protection switch Q6, the switch Q3, the switch Q2, and the switch S2 are turned off. Since the switch S1 is on, the supply voltage Vdrv charges the bootstrap capacitor Cb3 via the charging switch Db3, the voltage across the bootstrap capacitor Cb3 increases, and a current flows back to the reference ground GND and the capacitor Cdr via the switch S1. Since the switch Q4 is on, the bootstrap capacitor Cb6 charges the bootstrap capacitor Cb5 via the charging switch Db5, the voltage across the bootstrap capacitor Cb5 increases, and a current flows back to the bootstrap capacitor Cb6 via the switch Q4.

In the embodiment of FIG. 14A, when the voltage across the bootstrap capacitor Cb1 is insufficient to supply the driver 241 for providing the driving signal Vg5, the protection switch Q5 is off. Before the protection switch Q5 is turned on, the bootstrap capacitor Cb2 charges the bootstrap capacitor Cb1 via the charging switch Db1 when the switch Q1 is on. The voltage across the bootstrap capacitor Cb1 increases, and the current charging the bootstrap capacitor Cb1 flows back to the bootstrap capacitor Cb2 via the parasitic diode of the protection switch Q5 and via the switch Q1. In one embodiment, when the voltage across the bootstrap capacitor Cb1 is sufficient to turn on the protection switch Q5, the non-isolated switching converter 900 enters the second switching mode.

FIG. 14B schematically shows the non-isolated switching converter 900 working in the second switching mode in accordance with an embodiment of the present invention. In the embodiment of FIG. 14B, in the second switching mode, the protection switch Q5, the switch Q1, the switch Q4, and the switch S1 are turned on, and the protection switch Q6, the switch Q3, the switch Q2, and the switch S2 are turned off. Since the switch Q1 and the protection switch Q5 are on, the bootstrap capacitor Cb2 charges the bootstrap capacitor Cb1 via the charging switch Db1, the voltage across the bootstrap capacitor Cb1 increases, and a current flows back to the bootstrap capacitor Cb2 via the protection switch Q5 and the switch Q1.

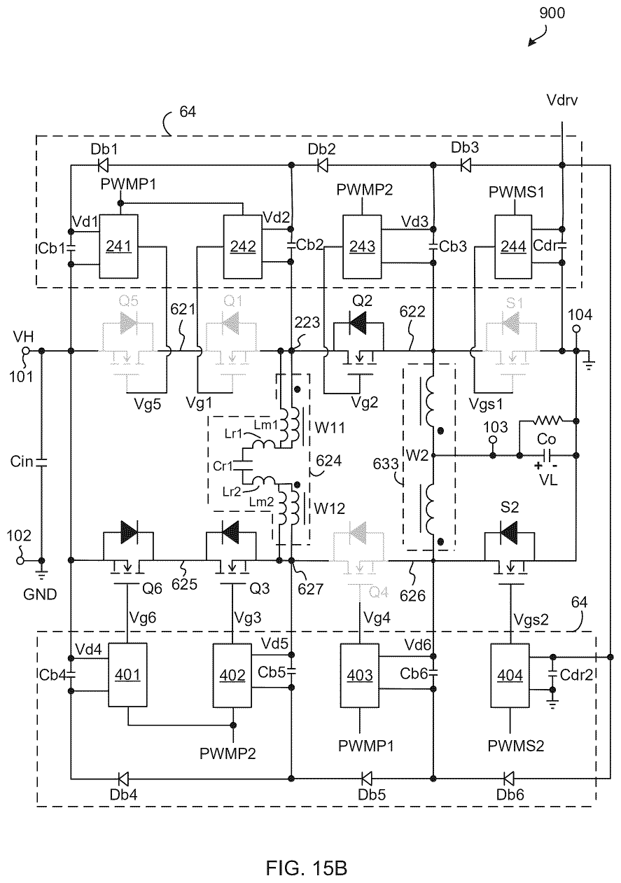

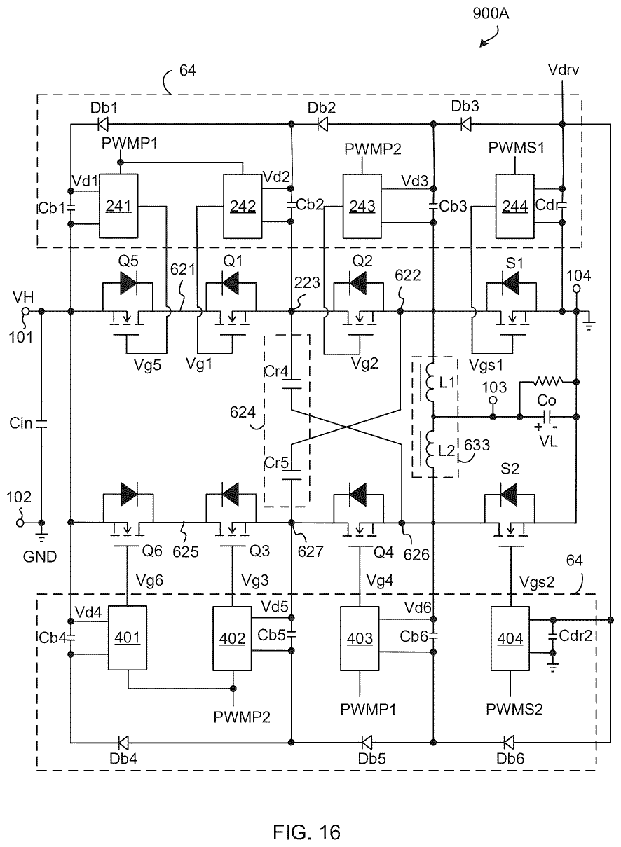

FIG. 15A schematically shows the non-isolated switching converter 900 working in the third switching mode in accordance with an embodiment of the present invention. In the embodiment of FIG. 15A, in the third switching mode, the switch Q3, the switch Q2, and the switch S2 are turned on, and the protection switch Q5, the switch Q1, the switch Q4, and the switch S1 are turned off. Since the switch S2 is on, the supply voltage Vdrv charges the bootstrap capacitor Cb6 via the charging switch Db6, the voltage across the bootstrap capacitor Cb6 increases, and a current flows back to the reference ground GND and the capacitor Cdr2 via the switch S2. Since the switch Q2 is on, the bootstrap capacitor Cb3 charges the bootstrap capacitor Cb2 via the charging switch Db2, the voltage across the bootstrap capacitor Cb2 increases, and a current flows back to the bootstrap capacitor Cb3 via the switch Q2.

In the embodiment of FIG. 15A, when the voltage across the bootstrap capacitor Cb4 is insufficient to supply the driver 401 for providing the driving signal Vg6, the protection switch Q6 is off. Before the protection switch Q6 is turned on, the bootstrap capacitor Cb5 charges the bootstrap capacitor Cb4 via the charging switch Db4 when the switch Q3 is on. The voltage across the bootstrap capacitor Cb4 increases, and the current charging the bootstrap capacitor Cb4 flows back to the bootstrap capacitor Cb5 via the parasitic diode of the protection switch Q6 and via the switch Q3. In one embodiment, when the voltage across the bootstrap capacitor Cb4 is sufficient to turn on the protection switch Q6, the non-isolated switching converter 900 enters a fourth switching mode.

FIG. 15B schematically shows the non-isolated switching converter 900 working in the fourth switching mode in accordance with an embodiment of the present invention. In the embodiment of FIG. 15B, in the fourth switching mode, the protection switch Q6, the switch Q3, the switch Q2, and the switch S2 are turned on, and the protection switch Q5, the switch Q1, the switch Q4, and the switch S1 are turned off. Since the switch Q3 and the protection switch Q6 are on, the bootstrap capacitor Cb5 charges the bootstrap capacitor Cb4 via the charging switch Db4, the voltage across the bootstrap capacitor Cb4 increases, and a current flows back to the bootstrap capacitor Cb5 via the protection switch Q6 and the switch Q3.

FIG. 16 schematically shows a circuit diagram of a non-isolated switching converter 900A in accordance with an embodiment of the present invention. In the embodiment of FIG. 16, the energy storage circuit 624 comprises an energy storage capacitor Cr4 and an energy storage capacitor Cr5. One end of the energy storage capacitor Cr4 is coupled to the common node 223 of the switch Q1 and the switch Q2, and another end of the energy storage capacitor Cr4 is coupled to the low voltage side circuit via the fourth terminal 626 of the high voltage side circuit, e.g., coupled to the magnetic component 633 and the drain terminal of the switch S1. One end of the energy storage capacitor Cr5 is coupled to the common node 627 of the switch Q3 and the switch Q4, and another end of the energy storage capacitor Cr5 is coupled to the low voltage side circuit via the second terminal 622 of the high voltage side circuit, e.g., coupled to the magnetic component 633 and the drain terminal of the switch S2. In the embodiment of FIG. 16, the magnetic component 633 comprises inductors L1-L2. In some examples, the inductors L1-L2 may be replaced by a transformer. One end of the magnetic component L1 is coupled to the second terminal 622 of the high voltage side circuit and the drain terminal of the switch S1, another end of the magnetic component L1 and one end of the magnetic component L2 are both coupled to the voltage terminal 103, and another end of the magnetic component L2 is coupled to the fourth terminal 626 of the high voltage side circuit and the drain terminal of the switch S2.

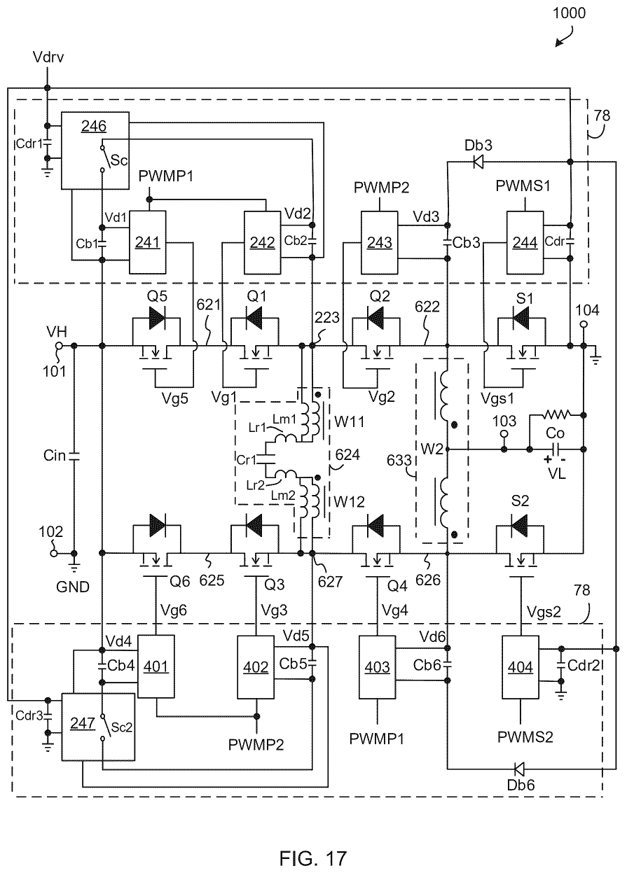

FIG. 17 schematically shows a circuit diagram of a non-isolated switching converter 1000 in accordance with an embodiment of the present invention. In the embodiment of FIG. 17, a driving circuit 78 comprises the charging circuit 246 and a charging circuit 247. As illustrated above, the charging circuit 246 charges the bootstrap capacitors Cb1 and Cb2, which is not described here for brevity.

The charging circuit 247 charges the bootstrap capacitor Cb4 and the bootstrap capacitor Cb5. The charging circuit 247 is coupled to both ends of a capacitor Cdr3 to receive the supply voltage Vdrv. The charging circuit 247 provides the voltage Vd4 at the both ends of the bootstrap capacitor Cb4 and provides the voltage Vd5 at the both ends of the bootstrap capacitor Cb5. In one embodiment, the supply voltage Vdrv charges the bootstrap capacitor Cb5 via the charging circuit 247. In one embodiment, the charging circuit 247 comprises a charging switch Sc2 coupled between the bootstrap capacitor Cb4 and the bootstrap capacitor Cb5. When the protection switch Q6 and the switch Q3 are turned on, the charging switch Sc2 is turned on, and the bootstrap capacitor Cb5 charges the bootstrap capacitor Cb4 via the charging switch Sc2. In one embodiment, the driving circuit 78 is integrated in one or more driving ICs, for example but not limited to, the driver 241, the driver 242, and the charging circuit 246 are integrated in a driving IC, the driver 401, the driver 402, and the charging circuit 247 are integrated in a driving IC, the driver 243 and the driver 244 are integrated in a driving IC, and the driver 403 and the driver 404 are integrated in a driving IC.

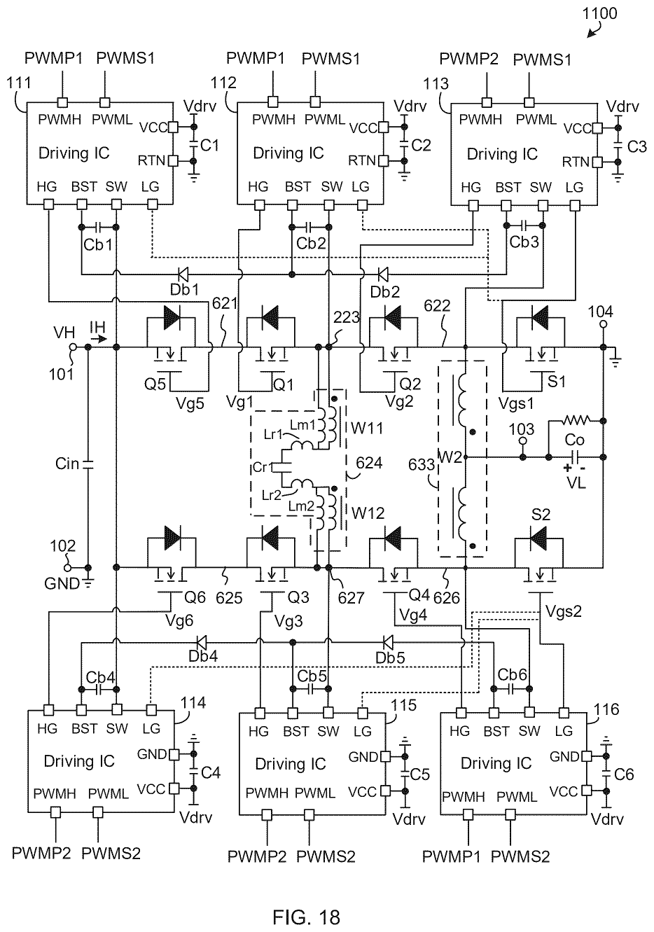

FIG. 18 schematically shows a circuit diagram of a non-isolated switching converter 1100 in accordance with an embodiment of the present invention. The non-isolated switching converter 1100 comprises driving ICs 111-116. Each of the driving ICs 111-116 comprises a control input pin PWMH, a control input pin PWML, a supply pin VCC, a ground pin RTN, a bootstrap pin BST, a switch pin SW, a driving output pin HG, and a driving output pin LG. The supply pin VCC of each of the driving ICs 111-116 is coupled to the supply voltage Vdrv, and a capacitor is coupled between the supply pin VCC and the ground pin RTN of each of the driving ICs 111-116, e.g., capacitors C1-C6 shown in FIG. 18. A bootstrap capacitor is coupled between the bootstrap pin BST and the switch pin SW of each of the driving ICs 111-116, e.g., the bootstrap capacitors Cb1-Cb6 shown in FIG. 18. Each of the driving ICs 111-116 provides a driving signal at its driving output pin HG based on a control signal received at its control input pin PWMH, and provides a driving signal at its driving output pin LG based on a control signal received at its control input pin PWML.

In one embodiment, the driving IC 111 receives the control signal PWMP1 at its control input pin PWMH and provides the driving signal Vg5 at its driving output pin HG. The driving IC 112 receives the control signal PWMP1 at its control input pin PWMH and provides the driving signal Vg1 at its driving output pin HG. When the switch Q1 and the protection switch Q5 are turned on, the bootstrap capacitor Cb2 charges the bootstrap capacitor Cb1 via the charging switch Db1, wherein the bootstrap capacitor Cb2 is coupled between the bootstrap pin BST and the switch pin SW of the driving IC 112, and the bootstrap capacitor Cb1 is coupled between the bootstrap pin BST and the switch pin SW of the driving IC 111. The driving IC 113 receives the control signal PWMP2 at its control input pin PWMH, receives the control signal PWMS1 at its control input pin PWML, provides the driving signal Vg2 at its driving output pin HG, and provides the driving signal Vgs1 at its driving output pin LG. When the switch Q2 is turned on, the bootstrap capacitor Cb3 charges the bootstrap capacitor Cb2 via the charging switch Db2, wherein the bootstrap capacitor Cb3 is coupled between the bootstrap pin BST and the switch pin SW of the driving IC 113. When the switch S1 is turned on, the supply voltage Vdrv charges the bootstrap capacitor Cb3 via internal circuits of the driving IC 113. In one embodiment, one or both of the driving IC 111 and the driving IC 112 further receive the control signal PWMS1 respectively at their control input pins PWML, and provide a driving signal to the switch S1 respectively at their driving output pins LG (e.g., shown by dashed lines connected to the driving IC 111 and dashed lines connected to the driving IC 112 in FIG. 18) to enhance driving capability for driving the switch S1.

In one embodiment, the driving IC 114 receives the control signal PWMP2 at its control input pin PWMH and provides the driving signal Vg6 at its driving output pin HG. The driving IC 115 receives the control signal PWMP2 at its control input pin PWMH and provides the driving signal Vg3 at its driving output pin HG. When the switch Q3 and the protection switch Q6 are turned on, the bootstrap capacitor Cb5 charges the bootstrap capacitor Cb4 via the charging switch Db4, wherein the bootstrap capacitor Cb5 is coupled between the bootstrap pin BST and the switch pin SW of the driving IC 115, and the bootstrap capacitor Cb4 is coupled between the bootstrap pin BST and the switch pin SW of the driving IC 114. The driving IC 116 receives the control signal PWMP1 at its control input pin PWMH, receives the control signal PWMS2 at its control input pin PWML, provides the driving signal Vg4 at its driving output pin HG, and provides the driving signal Vgs2 at its driving output pin LG. When the switch Q4 is turned on, the bootstrap capacitor Cb6 charges the bootstrap capacitor Cb5 via the charging switch Db5, wherein the bootstrap capacitor Cb6 is coupled between the bootstrap pin BST and the switch pin SW of the driving IC 116. When the switch S2 is turned on, the supply voltage Vdrv charges the bootstrap capacitor Cb6 via internal circuits of the driving IC 116. In one embodiment, one or both of the driving IC 114 and the driving IC 115 further receive the control signal PWMS2 respectively at their control input pins PWML, and provide a driving signal to the switch S2 respectively at their driving output pins LG (e.g., shown by dashed lines connected to the driving IC 114 and dashed lines connected to the driving IC 115 in FIG. 18) to enhance driving capability for driving the switch S2.

One with ordinary skill in the art should understand that the number and connection of the driving ICs 111-116 are not limited by the example shown in FIG. 18. In some other embodiments, one or more of the driving ICs shown in FIG. 18 may also be combined with other types of driving ICs or driving circuits to drive the switches of the non-isolated switching converter 1100.

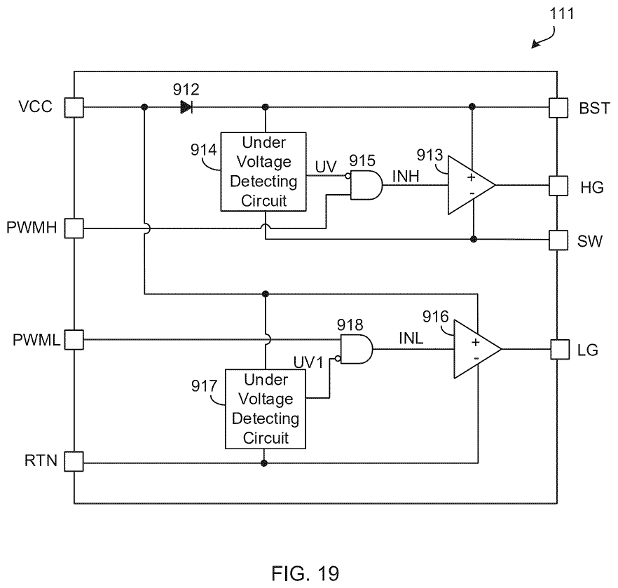

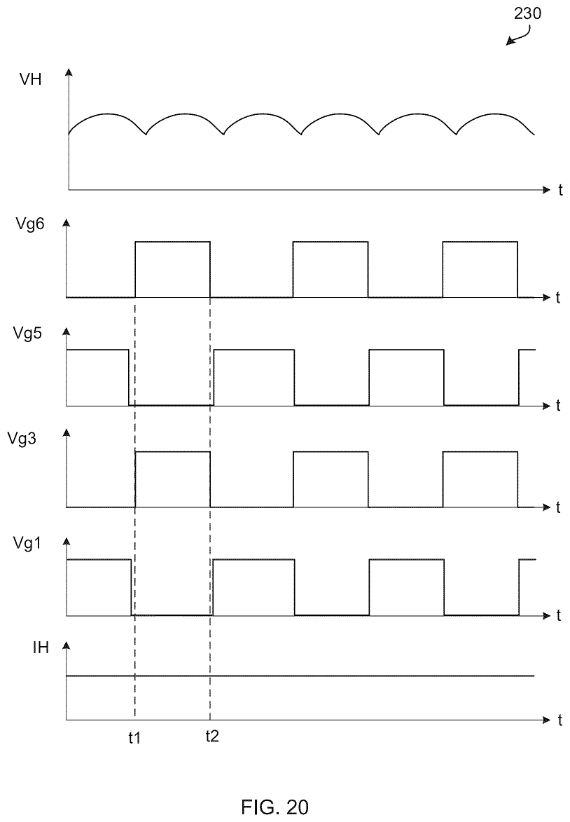

FIG. 19 schematically shows the driving IC 111 in accordance with an embodiment of the present invention. Internal circuit structures of the driving ICs 112-116 are similar to that of the driving IC 111 and are not described here for brevity. As shown in FIG. 19, the driving IC 111 comprises a charging switch 912 coupled between its supply pin VCC and the bootstrap pin BST, a driver 913, and a driver 916. The charging switch 912 may be, for example, a diode or other types of controllable switches.

In the embodiment of FIG. 19, the driver 913 has a positive power supply terminal coupled to the bootstrap pin BST of the driving IC 111 and a negative power supply terminal coupled to the switch pin SW of the driving IC 111, and a voltage between the bootstrap pin BST and the switch pin SW supplies the driver 913. In other words, a bootstrap capacitor coupled between the bootstrap pin BST and the switch pin SW of the driving IC 111 supplies the driver 913. The driver 913 provides a driving signal at the driving output pin HG of the driving IC 111 based on a control signal received at the control input pin PWMH of the driving IC 111. In one embodiment, the driving IC 111 further comprises an undervoltage detection circuit 914 and a logic circuit 915. The undervoltage detection circuit 914 is coupled between the bootstrap pin BST and the switch pin SW of the driving IC 111, and provides an undervoltage signal UV based on whether the voltage between the bootstrap pin BST and the switch pin SW of the driving IC 111 is lower than a undervoltage threshold of the undervoltage detection circuit 914. The logic circuit 915 is coupled to the undervoltage detection circuit 914 and the control input pin PWMH, and the logic circuit 915 provides a control signal INH at its output terminal based on the undervoltage signal UV and the control signal received at the control input pin PWMH of the driving IC 111. The driver 913 is coupled to the logic circuit 915, and the driver 913 provides a driving signal at the driving output pin HG of the driving IC 111 based on the control signal INH provided by the logic circuit 915. It is indicated that the power supply of the driver 913 is insufficient if the undervoltage detection circuit 914 detects that the voltage between the bootstrap pin BST and the switch pin SW of the driving IC 111 is lower than the undervoltage threshold of the undervoltage detection circuit 914, then the driver 913 stops providing the driving signal at the driving output pin HG of the driving IC 111 based on the control signal received at the control input pin PWMH.

In the embodiment of FIG. 19, the driver 916 has a positive power supply terminal coupled to the supply pin VCC of the driving IC 111 and a negative power supply terminal coupled to the ground pin RTN of the driving IC 111, and the supply voltage Vdrv between the supply pin VCC and the ground pin RTN supplies the driver 916. The driver 916 provides a driving signal at its driving output pin LG based on a control signal received at its control input pin PWML. In one embodiment, the driving IC 111 further comprises an undervoltage detection circuit 917 and a logic circuit 918. The undervoltage detection circuit 917 is coupled between the supply pin VCC and the ground pin RTN of the driving IC 111 and provides an undervoltage signal UV1 based on whether the supply voltage Vdrv is lower than an undervoltage threshold of the undervoltage detection circuit 917. The logic circuit 918 is coupled to the undervoltage detection circuit 917 and the control input pin PWML and provides a control signal INL at its output terminal based on the undervoltage signal UV1 and the control signal received at the control input pin PWML of the driving IC 111. The driver 916 is coupled to the logic circuit 918, and the driver 916 provides a driving signal at the driving output pin LG of the driving IC 111 based on the control signal INL provided by the logic circuit 918. It is indicated that the power supply of the driver 916 is insufficient if the undervoltage detection circuit 917 detects that the voltage between the bootstrap pin BST and the switch pin SW is lower than the undervoltage threshold of the undervoltage detection circuit 917, then the driver 916 stops providing the driving signal at the driving output pin LG of the driving IC 111 based on the control signal received at the control input pin PWML.

FIG. 20 shows waveforms 230 of the non-isolated switching converter 1100 shown in FIG. 18 in accordance with an embodiment of the present invention. As shown in FIG. 20, from top to bottom are waveforms of the voltage VH, the driving signal Vg6, the driving signal Vg5, the driving signal Vg3, the driving signal Vg1, and a current IH flowing into the non-isolated switch converter 1100. As shown in FIG. 20, the current IH is positive, and the non-isolated switch converter 1100 operates in the forward mode. At a time t1, the driving signal Vg5 and the driving signal Vg1 transits to a low voltage level so that the protection switch Q5 and the switch Q1 are turned off, the driving signal Vg6 and the driving signal Vg3 transits to the high voltage level to turn on the protection switch Q6 and the switch Q3, and at this time the bootstrap capacitor Cb5 charges the bootstrap capacitor Cb4. At a time t2, the driving signal Vg6 and the driving signal Vg3 transits to the low voltage level so that the protection switch Q6 and the switch Q3 are turned off, the driving signal Vg5 and the driving signal Vg1 transits to the high voltage level to turn on the protection switch Q5 and the switch Q1, and at this time the bootstrap capacitor Cb2 charges the bootstrap capacitor Cb1. In one embodiment, a voltage level between a high threshold voltage (e.g. 2V) and a voltage source (e.g. 3.3V) is the high voltage level, a voltage level between zero voltage (0 V) and a low threshold voltage (e.g. 1V) is the low voltage level, and a voltage level between the high threshold voltage and the low threshold voltage is a middle voltage level.

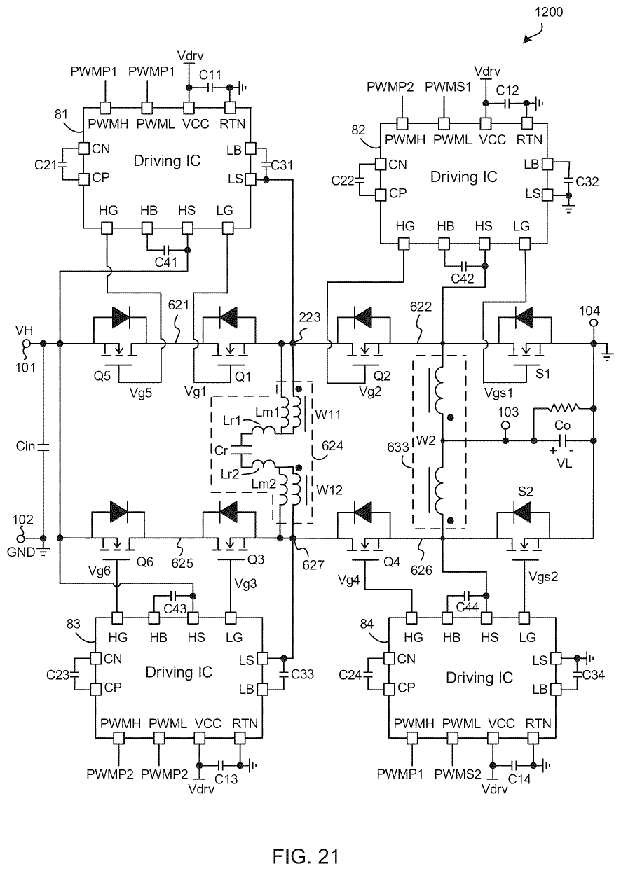

FIG. 21 schematically shows a circuit diagram of a non-isolated switching converter 1200 in accordance with an embodiment of the present invention. The non-isolated switching converter 1200 comprises driving ICs 81-84. Each of the driving ICs 81-84 comprises a control input pin PWMH, a control input pin PWML, a supply pin VCC, a ground pin RTN, a charge pump pin CN, a charge pump pin CP, a driving supply pin LB, a driving supply return pin LS, a driving supply pin HB, a driving supply return pin HS, a driving output pin HG, and a driving output pin LG. The supply pin VCC of each of the driving ICs 81-84 is coupled to the supply voltage Vdrv, and a capacitor is coupled between the supply pin VCC and the ground pin RTN of each of the driving ICs 81-84, e.g., capacitors C11-C14 shown in FIG. 21. A flying capacitor is coupled between the charge pump pin CP and the charge pump pin CN of each of the driving ICs 81-84, e.g., flying capacitors C21-C24 shown in FIG. 21. A bootstrap capacitor is coupled between the driving supply pin LB and the driving supply return pin LS of each of the driving ICs 81-84, e.g., bootstrap capacitors C31-C34 shown in FIG. 21. A bootstrap capacitor is coupled between the driving supply pin HB and the driving supply return pin HS of each of the driving ICs 81-84, e.g., bootstrap capacitors C41-C44 shown in FIG. 21. Each of the driving ICs 81-84 provides a driving signal at its driving output pin HG based on a control signal received at its control input pin PWMH, and provides a driving signal at its driving output pin LG based on a control signal received at its control input pin PWML.

In one embodiment, the driving IC 81 receives the control signal PWMP1 at both of its control input pins PWMH and PWML, provides the driving signal Vg5 at its driving output pin HG based on the control signal PWMP1, and provides the driving signal Vg1 at its driving output pin LG based on the control signal PWMP1. The flying capacitor C21 coupled between the charge pump pin CP and the charge pump pin CN charges the bootstrap capacitor C31 coupled between the driving supply pin LB and the driving supply return pin LS of the driving IC 81. When the protection switch Q5 and the switch Q1 are turned on, the bootstrap capacitor C31 charges the bootstrap capacitor C41 coupled between the driving supply pin HB and the driving supply return pin HS of the driving IC 81. The driving IC 82 receives the control signal PWMP2 at its control input pin PWMH, and provides the driving signal Vg2 at its driving output pin HG based on the control signal PWMP2, and the driving IC 82 further receives the control signal PWMS1 at its control input pin PWML, and provides the driving signal Vgs1 at its driving output pin LG based on the control signal PWMS1. The driving supply return pin LS of the driving IC 82 is coupled to the reference ground GND, and the supply voltage Vdrv charges the bootstrap capacitor C32 coupled between the driving supply pin LB and the driving supply return pin LS of the driving IC 82. When the switch S1 is turned on, the bootstrap capacitor C32 charges the bootstrap capacitor C42 coupled between the driving supply pin HB and the driving power return pin HS of the driving IC 82.

In one embodiment, the driving IC 83 receives the control signal PWMP2 at both of its control input pins PWMH and PWML, provides the driving signal Vg6 at its driving output pin HG based on the control signal PWMP2, and provides the driving signal Vg3 at its driving output pin LG based on the control signal PWMP2. The flying capacitor C23 coupled between the charge pump pin CP and the charge pump pin CN of the driving IC 83 charges the bootstrap capacitor C33 coupled between the driving supply pin LB and the driving supply return pin LS of the driving IC 83. When the protection switch Q6 and the switch Q3 are turned on, the bootstrap capacitor C33 charges the bootstrap capacitor C43 coupled between the driving supply pin HB and the driving supply return pin HS of the driving IC 83. The driving IC 84 receives the control signal PWMP1 at its control input pin PWMH, and provides the driving signal Vg4 at its driving output pin HG based on the control signal PWMP1, and the driving IC 84 further receives the control signal PWMS2 at its control input pin PWML, and provides the driving signal Vgs2 at its driving output pin LG based on the control signal PWMS2. The driving supply return pin LS of the driving IC 84 is coupled to the reference ground GND, and the supply voltage Vdrv charges the bootstrap capacitor C34 coupled between the driving supply pin LB and the driving supply return pin LS of the driving IC 84. When the switch S2 is turned on, the bootstrap capacitor C34 charges the bootstrap capacitor C44 coupled between the driving supply pin HB and the driving power return pin HS of the driving IC 84.

One with ordinary skill in the art should understand that the number and connection of the driving ICs 81-84 are not limited by the example shown in FIG. 21. In some other embodiments, one or more of the driving ICs shown in FIG. 21 may also be combined with other types of driving ICs or driving circuits to drive the switches of the non-isolated switching converter 1200.

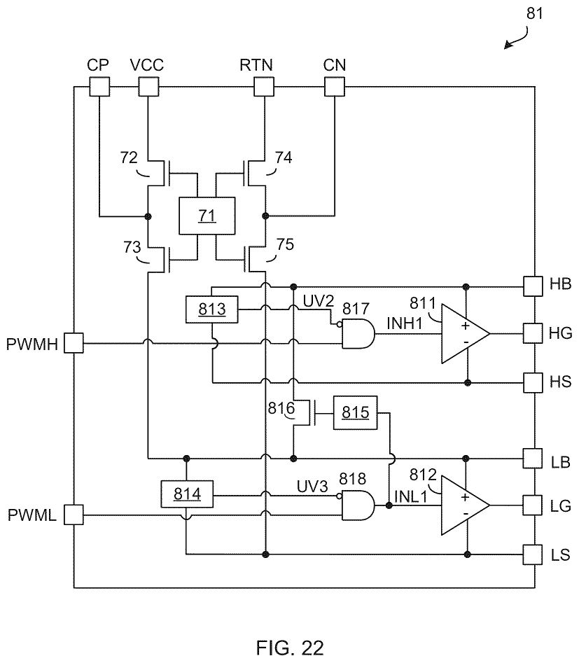

FIG. 22 schematically shows the driving IC 81 in accordance with an embodiment of the present invention. Internal circuit structures of the driving ICs 82-84 are similar to that of the driving IC 81, and are not described here for brevity. As shown in FIG. 22, the driving IC 81 comprises a charge pump circuit comprising the switches 72-75 and the oscillator 71, a driver 811, a driver 812, and a charging switch 816. The common node of the switch 72 and the switch 73 is coupled to the charge pump pin CP of the driving IC 81, and the common node of the switch 74 and the switch 75 is coupled to the charge pump pin CN of the driving IC 81.

In the embodiment of FIG. 22, the driver 811 has a positive power supply terminal coupled to the driving supply pin HB of the driving IC 81 and a negative power supply terminal coupled to the driving supply return pin HS of the driving IC 81. A bootstrap capacitor (not shown in FIG. 22) coupled between the driving supply pin HB and the driving supply return pin HS supplies the driver 811. The driver 811 provides a driving signal at the driving output pin HG of the driving IC 81 based on a control signal received at the control input pin PWMH of the driving IC 81. In one embodiment, the driving IC 81 further comprises an undervoltage detection circuit 813 and a logic circuit 817. The undervoltage detection circuit 813 is coupled between the driving supply pin HB and the driving supply return pin HS of the driving IC 81 and provides an undervoltage signal UV2 based on whether the voltage between the driving supply pin HB and the driving supply return pin HS of the driving IC 81 is lower than a undervoltage threshold of the undervoltage detection circuit 813. The logic circuit 817 is coupled to the undervoltage detection circuit 813 and the control input pin PWMH, and the logic circuit 817 provides a control signal INH1 at its output terminal based on the undervoltage signal UV2 and the control signal received at the control input pin PWMH of the driving IC 81. The driver 811 is coupled to the logic circuit 817, and the driver 811 provides a driving signal at the driving output pin HG of the driving IC 81 based on the control signal INH1 provided by the logic circuit 817. It is indicated that the power supply of the driver 811 is insufficient if the undervoltage detection circuit 813 detects that the voltage between the driving supply pin HB and the driving supply return pin HS of the driving IC 81 is lower than the undervoltage threshold of the undervoltage detection circuit 813, then the driver 811 stops providing the driving signal at the driving output pin HG of the driving IC 81 based on the control signal received at the control input pin PWMH.

In the embodiment of FIG. 22, the driver 812 has a positive power supply terminal coupled to the driving supply pin LB of the driving IC 81 and a negative power supply terminal coupled to the driving supply return pin LS of the driving IC 81. A bootstrap capacitor (not shown in FIG. 22) coupled between the driving supply pin LB and the driving supply return pin LS supplies the driver 812. The driver 812 provides a driving signal at the driving output pin LG of the driving IC 81 based on a control signal received at the control input pin PWML of the driving IC 81. In one embodiment, the driving IC 81 further comprises an undervoltage detection circuit 814 and a logic circuit 818. The undervoltage detection circuit 814 is coupled between the driving supply pin LB and the driving supply return pin LS of the driving IC 81 and provides an undervoltage signal UV3 based on whether the voltage between the driving supply pin LB and the driving supply return pin LS of the driving IC 81 is lower than a undervoltage threshold of the undervoltage detection circuit 814. The logic circuit 818 is coupled to the undervoltage detection circuit 814 and the control input pin PWML, and the logic circuit 818 provides a control signal INL1 at its output terminal based on the undervoltage signal UV3 and the control signal received at the control input pin PWML of the driving IC 81. The driver 812 is coupled to the logic circuit 818, and the driver 812 provides a driving signal at the driving output pin LG of the driving IC 81 based on the control signal INL1 provided by the logic circuit 818. It is indicated that the power supply of the driver 812 is insufficient if the undervoltage detection circuit 814 detects that the voltage between the driving supply pin LB and the driving supply return pin LS of the driving IC 81 is lower than the undervoltage threshold of the undervoltage detection circuit 814, then the driver 812 stops providing the driving signal at the driving output pin LG of the driving IC 81 based on the control signal received at the control input pin PWML. The charging switch 816 is coupled between the driving supply pin HB and the driving supply pin LB. The bootstrap capacitor coupled between the driving supply pin HB and the driving supply return pin HS of the driving IC 81 may be charged by a voltage between the driving supply pin LB and the driving supply return pin LS of the driving IC 81 via the charging switch 816. In one embodiment, when the driving output pin LG of the driving IC 81 outputs a driving signal to turn on a corresponding switch, the control circuit 815 turns on the charging switch 816.

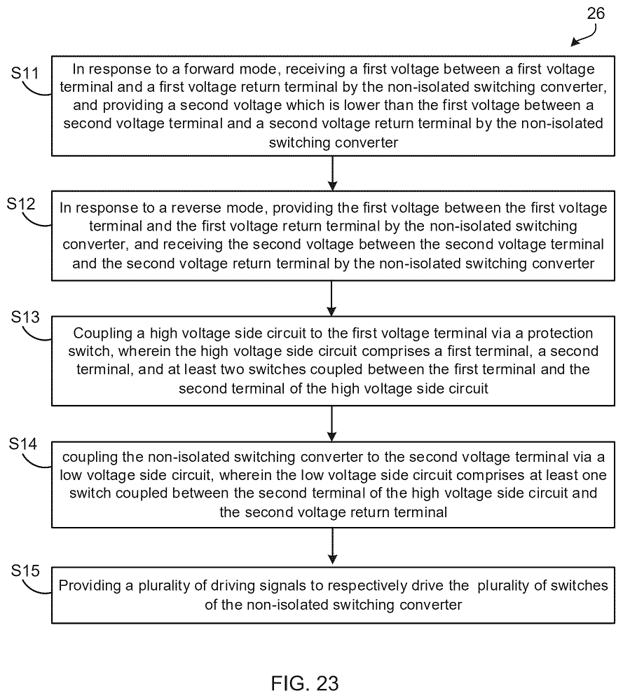

FIG. 23 illustrates a control method 26 for a non-isolated switching converter in accordance with an embodiment of the present invention. The control method 26 comprises steps S11-S15.

In step S11, in response to a forward mode, receiving a first voltage between a first voltage terminal and a first voltage return terminal by the non-isolated switching converter, and providing a second voltage which is lower than the first voltage between a second voltage terminal and a second voltage return terminal by the non-isolated switching converter.

In step S12, in response to a reverse mode, providing the first voltage between the first voltage terminal and the first voltage return terminal by the non-isolated switching converter, and receiving the second voltage between the second voltage terminal and the second voltage return terminal by the non-isolated switching converter.

In step S13, coupling a high voltage side circuit to the first voltage terminal via a protection switch, wherein the high voltage side circuit comprises a first terminal, a second terminal, and at least two switches coupled between the first terminal and the second terminal of the high voltage side circuit.

In step S14, coupling the non-isolated switching converter to the second voltage terminal via a low voltage side circuit, wherein the low voltage side circuit comprises at least one switch coupled between the second terminal of the high voltage side circuit and the second voltage return terminal.

In step S15, providing a plurality of driving signals to respectively drive the plurality of switches of the non-isolated switching converter.

Note that in the control method described above, the functions indicated in the boxes can also occur in different orders than those shown in FIG. 23. For example, two boxes presented one after another can actually be executed essentially at the same time, or sometimes in reverse order, depending on the specific functionality involved.

Obviously many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. A non-isolated switching converter, comprising:
a first voltage terminal and a first voltage return terminal;
a second voltage terminal and a second voltage return terminal, wherein the second voltage return terminal is coupled to the first voltage return terminal;
a first protection switch coupled to the first voltage terminal;
a high voltage side circuit comprising a first terminal, a second terminal, and a first switch and a second switch coupled in series between the first terminal and the second terminal of the high voltage side circuit, wherein the first terminal of the high voltage side circuit is coupled to the first voltage terminal via the first protection switch, and wherein the first protection switch and the first switch are coupled in a back-to-back manner; and
a low voltage side circuit coupled to the second voltage terminal and the second voltage return terminal, wherein the low voltage side circuit comprises a third switch coupled between the second terminal of the high voltage side circuit and the second voltage return terminal; wherein
in response to a forward mode, the non-isolated switching converter is configured to receive a first voltage between the first voltage terminal and the first voltage return terminal and provide a second voltage between the second voltage terminal and the second voltage return terminal; and wherein
in response to a reverse mode, the non-isolated switching converter is configured to provide the first voltage between the first voltage terminal and the first voltage return terminal and receive the second voltage between the second voltage terminal and the second voltage return terminal.

2. The non-isolated switching converter of claim 1, wherein each one of the first protection switch, the first switch, the second switch, and the third switch comprises a source terminal, a drain terminal and a control terminal, and wherein:
the source terminal of the first protection switch is coupled to the first voltage terminal;
the drain terminal of the first switch is coupled to the drain terminal of the first protection switch;
the drain terminal of the second switch is coupled to the source terminal of the first switch; and
the drain terminal of the third switch is coupled to the source terminal of the second switch, and the source terminal of the third switch is coupled to a reference ground.

3. The non-isolated switching converter of claim 2, further comprising:
a driving circuit capable of receiving a first control signal, providing a first driving signal to the control terminal of the first protection switch based on the first control signal, providing a second driving signal to the control terminal of the first switch based on the first control signal, receiving a second control signal, providing a third driving signal to the control terminal of the second switch based on the second control signal, receiving a third control signal, and providing a fourth driving signal to the control terminal of the third switch based on the third control signal; wherein
during a first time period, the driving circuit is further capable of keeping the first protection switch, the first switch, and the third switch on, while keeping the second switch off; and wherein
during a second time period, the driving circuit is further capable of keeping the first protection switch, the first switch, and the third switch off, while keeping the second switch on.

4. The non-isolated switching converter of claim 1, further comprising:
a first driver capable of providing a first driving signal to turn on and off the first protection switch;
a first capacitor coupled to the first voltage terminal, and the first driver is powered by a voltage across the first capacitor;
a second driver capable of providing a second driving signal to turn on and off the first switch; and
a second capacitor coupled to a common node of the first switch and the second switch, and the second driver is powered by a voltage across the second capacitor; wherein
the second capacitor is configured to charge the first capacitor when the first switch is on, wherein a current for charging the first capacitor flows through the first switch and the first protection switch.

5. The non-isolated switching converter of claim 4, further comprising:
a third driver capable of providing a third driving signal to turn on and off the second switch;
a third capacitor coupled to the second terminal of the high voltage side circuit, and the third driver is powered by a voltage across the third capacitor; and
a fourth driver capable of receiving a supply voltage and providing a fourth driving signal to turn on and off the third switch; wherein
the third capacitor is configured to charge the second capacitor when the second switch is on; and wherein
the supply voltage is configured to charge the third capacitor when the third switch is on.

6. The non-isolated switching converter of claim 4, further comprising:
a charge pump circuit capable of receiving the supply voltage; and
a flying capacitor comprising two ends coupled to the charge pump circuit, wherein the charge pump circuit is capable of charging the flying capacitor, and the flying capacitor is capable of charging the second capacitor.

7. The non-isolated switching converter of claim 1, wherein the high voltage side circuit further comprises:
an energy storage circuit comprising a first terminal and a second terminal, wherein the first terminal of the energy storage circuit is coupled to the common node of the first switch and the second switch, and the second terminal of the energy storage circuit is coupled to the low voltage side circuit.

8. The non-isolated switching converter of claim 1, further comprising a second protection switch coupled to the first voltage terminal, wherein the high voltage side circuit further comprises:
a third terminal, a fourth terminal, and a fourth switch and a fifth switch coupled in series between the third terminal and the fourth terminal of the high voltage side circuit, wherein the third terminal of the high voltage side circuit is coupled to the first voltage terminal via the second protection switch, and the fourth terminal of the high voltage side circuit is coupled to the low voltage side circuit; and
an energy storage circuit comprising a first terminal and a second terminal, wherein the first terminal of the energy storage circuit is coupled to the common node of the first switch and the second switch, and the second terminal of the energy storage circuit is coupled to a common node of the fourth switch and the fifth switch.

9. The non-isolated switching converter of claim 1, wherein the high voltage side circuit further comprises:
a third terminal, a fourth terminal, and a fourth switch and a fifth switch coupled in series between the third terminal and the fourth terminal of the high voltage side circuit, wherein the third terminal of the high voltage side circuit is coupled to the first voltage terminal via the first protection switch, and the fourth terminal of the high voltage side circuit is coupled to the low voltage side circuit; and
an energy storage circuit comprising a first terminal and a second terminal, wherein the first terminal of the energy storage circuit is coupled to the common node of the first switch and the second switch, and the second terminal of the energy storage circuit is coupled to a common node of the fourth switch and the fifth switch.

10. A non-isolated switching converter, comprising:
a first voltage terminal and a first voltage return terminal;
a second voltage terminal and a second voltage return terminal, wherein the second voltage return terminal is coupled to the first voltage return terminal;
a first protection switch coupled to the first voltage terminal;
a second protection switch coupled to the first voltage terminal;
a high voltage side circuit comprising a first terminal, a second terminal, a third terminal, a fourth terminal, a first switch and a second switch coupled in series between the first terminal and the second terminal of the high voltage side circuit, and a third switch and a fourth switch coupled in series between the third terminal and the fourth terminal of the high voltage side circuit, wherein the first terminal of the high voltage side circuit is coupled to the first voltage terminal via the first protection switch, and the third terminal of the high voltage side circuit is coupled to the first voltage terminal via the second protection switch, and wherein the first protection switch and the first switch are coupled in a back-to-back manner, and the second protection switch and the third switch are coupled in the back-to-back manner;
a low voltage side circuit coupled to the second voltage terminal and the second voltage return terminal, wherein the low voltage side circuit comprises a fifth switch coupled between the second terminal of the high voltage side circuit and the second voltage return terminal, and a sixth switch coupled between the fourth terminal of the high voltage side circuit and the second voltage return terminal; and
an energy storage circuit comprising a first terminal and a second terminal, wherein the first terminal of the energy storage circuit is coupled to a common node of the first switch and the second switch, and the second terminal of the energy storage circuit is coupled to a common node of the fourth switch and the fifth switch; wherein
in response to a forward mode, the non-isolated switching converter is configured to receive a first voltage between the first voltage terminal and the first voltage return terminal and provide a second voltage between the second voltage terminal and the second voltage return terminal; and wherein
in response to a reverse mode, the non-isolated switching converter is configured to provide the first voltage between the first voltage terminal and the first voltage return terminal and receive the second voltage between the second voltage terminal and the second voltage return terminal.

11. The non-isolated switching converter of claim 10, wherein:
during a first time period, the non-isolated switching converter is capable of keeping the first protection switch, the first switch, the fourth switch, and the fifth switch on, while keeping the second protection switch, the second switch the third switch, and the sixth switch off; and wherein
during a second time period, the non-isolated switching converter is capable of keeping the first protection switch, the first switch, the fourth switch, and the fifth switch off, while keeping the second protection switch, the second switch the third switch, and the sixth switch on.

12. The non-isolated switching converter of claim 10, further comprising:
a first driver capable of providing a first driving signal for driving the first protection switch;
a first capacitor coupled to the first voltage terminal, and the first driver is powered by a voltage across the first capacitor;
a second driver capable of providing a second driving signal for driving the first switch;
a second capacitor coupled to the common node of the first switch and the second switch, and the second driver is powered by a voltage across the second capacitor;
a third driver capable of providing a third driving signal for driving the second switch;
a third capacitor coupled to the first voltage terminal, and the third driver is powered by a voltage across the third capacitor;
a fourth driver capable of providing a fourth driving signal for driving the third switch; and
a fourth capacitor coupled to a common node of the third switch and the fourth switch, and the fourth driver is powered by a voltage across the fourth capacitor; wherein
the second capacitor is configured to charge the first capacitor when the first switch is on, and the fourth capacitor is configured to charge the third capacitor when the third switch is on.

13. The non-isolated switching converter of claim 10, further comprising a driving integrated circuit (IC), wherein the driving IC comprises:
a control input pin capable of receiving a first control signal;
a driving output pin capable of providing a first driving signal to the first protection switch for driving the first protection switch;
a switch pin coupled to the first voltage terminal;
a bootstrap pin capable of being coupled to the switch pin via a first capacitor; and
a driver comprising an input terminal, an output terminal, a positive power supply terminal, and a negative power supply terminal, wherein the input terminal of the driver is coupled to the control input pin, the output terminal of the driver is coupled to the driving output pin, the positive power supply terminal of the driver is coupled to the bootstrap pin, and the negative power supply terminal of the driver is coupled to the switch pin, and wherein the first capacitor is capable of supplying the driver; wherein
the non-isolated switching converter is configured to charge the first capacitor when the first switch is on with a current flowing through the first switch and the first protection switch.

14. The non-isolated switching converter of claim 10, further comprising a driving IC, wherein the driving IC comprises:
a first control input pin and a second control input pin, wherein the first control input pin and the second control input pin are capable of receiving a first control signal;
a first driving output pin and a second driving output pin, wherein the driving IC is capable of providing a first driving signal at the first driving output pin based on the first control signal, and providing a second driving signal at the second driving output pin based on the first control signal, and wherein the first driving signal is capable of driving the first protection switch, and the second driving signal is capable of driving the first switch;
a power supply pin capable of receiving a supply voltage;
a ground pin capable of being coupled to a reference ground;
a first charge pump pin capable of being coupled to one end of a flying capacitor;
a second charge pump pin capable of being coupled to another end of the flying capacitor;
a first driving supply pin capable of being coupled to a first end of a first capacitor;
a first driving supply return pin capable of being coupled to a second end of the first capacitor and the first voltage terminal;
a second driving supply pin capable of being coupled to a first end of a second capacitor; and
a second driving supply return pin capable of being coupled to a second end of the second capacitor and the common node of the first switch and the second switch; wherein
the second capacitor is configured to charge the first capacitor when the first switch is on.

15. The non-isolated switching converter of claim 14, wherein the driving IC further comprises:
a first driver comprising an input terminal, an output terminal, a positive power supply terminal, and a negative power supply terminal, wherein the input terminal of the first driver is coupled to the first control input pin, the output terminal of the first driver is coupled to the first driving output pin, the positive power supply terminal of the first driver is coupled to the first driving supply pin, and the negative power supply terminal of the first driver is coupled to the first driving supply return pin, and wherein the first capacitor is capable of supplying the first driver; and
a second driver comprising an input terminal, an output terminal, a positive power supply terminal, and a negative power supply terminal, wherein the input terminal of the second driver is coupled to the second control input pin, the output terminal of the second driver is coupled to the second driving output pin, the positive power supply terminal of the second driver is coupled to the second driving supply pin, and the negative power supply terminal of the second driver is coupled to the second driving supply return pin, and wherein the second capacitor is capable of supplying the second driver.

16. The non-isolated switching converter of claim 10, further comprising:
a first driving IC capable of providing a first driving signal based on a first control signal to drive the first protection switch;
a second driving IC capable of providing a second driving signal based on the first control signal to drive the first switch;
a third driving IC capable of providing a third driving signal based on a second control signal to drive the second switch, and providing a fourth driving signal based on a third control signal to drive the fifth switch;
a fourth driving IC capable of providing a fifth driving signal based on the second control signal to drive the second protection switch;
a fifth driving IC capable of providing a sixth driving signal based on the second control signal to drive the third switch; and
a sixth driving IC capable of providing a seventh driving signal based on the first control signal to drive the fourth switch, and providing an eighth driving signal based on a fourth control signal to drive the sixth switch.

17. The non-isolated switching converter of claim 10, further comprising:
a first driving IC capable of providing a first driving signal based on a first control signal to drive the first protection switch, and providing a second driving signal based on the first control signal to drive the first switch;
a second driving IC capable of providing a third driving signal based on a second control signal to drive the second switch;
a third driving IC capable of providing a fifth driving signal based on the second control signal to drive the second protection switch, and providing a sixth driving signal based on the second control signal to drive the third switch; and
a fourth driving IC capable of providing a seventh driving signal based on the first control signal to drive the fourth switch, and providing an eighth driving signal based on a fourth control signal to drive the sixth switch.

18. A control method for a non-isolated switching converter, comprising:
coupling the non-isolated switching converter to a second voltage terminal of the non-isolated switching converter via a low voltage side circuit, wherein the low voltage side circuit comprises a third switch coupled between the second terminal of the high voltage side circuit and a voltage return terminal;
based on a first control signal, providing a first driving signal by a first driver to drive the protection switch and providing a second driving signal by a second driver to drive the first switch;
providing a third driving signal based on a second control signal by a third driver to drive the second switch; and
providing a fourth driving signal based on a third control signal by a fourth driver to drive the third switch.

19. The control method of claim 18, further comprising:
providing power to the first driver via a first capacitor, wherein a first end of the first capacitor is coupled to the first voltage terminal;
providing power to the second driver via a second capacitor, wherein a first end of the second capacitor is coupled to a second end of the first capacitor, and a second end of the second capacitor is coupled to a common node of the first switch and the second switch; and
charging the first capacitor by the second capacitor when the first switch is on, wherein a current for charging the first capacitor flows through the first switch and the first protection switch.

20. The control method of claim 19, further comprising:
charging a flying capacitor coupled to a charge pump circuit via the charge pump circuit; and
charging the second capacitor by the flying capacitor via the charge pump circuit.
